(19) United States
(12) Patent Application Publication
(10) Pub. No.: US 2024/0231184 A1
(43) Pub. Date: Jul. 11, 2024

(54) CAMERA ACTUATOR AND CAMERA MODULE COMPRISING SAME

(71) Applicant: LG INNOTEK CO., LTD., Seoul (KR)

(72) Inventor: Seung Hak LEE, Seoul (KR)

(21) Appl. No.: 18/559,100

(22) PCT Filed: Apr. 5, 2022
(86) PCT No.: PCT/KR2022/004836

§ 371 Date: Nov. 6, 2023

(30) Foreign Application Priority Data
May 6, 2021 (KR) 10-2021-0058606

(51) Int. Cl. G03B 5/00; G03B 17/17

(52) U.S. Cl. CPC G03B 5/00; G03B 17/17; G03B 2205/0023; G03B 2205/0069

(57) ABSTRACT

An embodiment of the present invention provides a camera actuator comprising: a housing; a mover which is arranged in the housing and includes an optical member; a tilting guide portion which guides tilting of the mover; and a driver which is arranged in the housing and drives the mover, wherein the driver comprises driving magnets including a 1st magnet and a third-first magnet arranged on one surface of the mover and a 2nd magnet and a third-second magnet arranged on the other surface facing the one surface. The 1st magnet and the 2nd magnet are adjacent to the tilting guide portion and have smaller area as compared with the third-first magnet and the third-second magnet.

### CROSS-REFERENCE TO RELATED APPLICATIONS

This application is the U.S. national stage application of International Patent Application No. PCT/KR2022/004836, filed Apr. 5, 2022, which claims the benefit under 35 U.S.C. § 119 of Korean Application No. 10-2021-0058606, filed May 6, 2021, the disclosures of each of which are incorporated herein by reference in their entirety.

### TECHNICAL FIELD

The present invention relates to a camera actuator and a camera module including the same.

### BACKGROUND ART

A camera is a device for making pictures or videos by photographing subjects and is mounted on a mobile device, a drone, a vehicle, etc. In order to improve the quality of the image, a camera module may have an image stabilization (IS) function for correcting or inhibiting the image shake caused by the movement of a user, an auto focusing (AF) function for aligning a focal length of a lens by automatically adjusting an interval between an image sensor and the lens, and a zooming function for capturing a remote subject by increasing or decreasing the magnification of the remote subject through a zoom lens.

Meanwhile, a pixel density of the image sensor increases as a resolution of the camera increases, and thus a size of the pixel becomes smaller, and as the pixel becomes smaller, the amount of light received for the same time decreases. Therefore, as the camera has a higher pixel density, the image shake caused by hand shaking due to a shutter speed decreased in a dark environment may more severely occur. As a representative IS technique, there is an optical image stabilizer (OIS) technique of correcting motion by changing a path of light.

According to a general OIS technique, the motion of the camera may be detected through a gyro sensor or the like, and a lens may tilt or move, or a camera module including the lens and an image sensor may tilt or move based on the detected motion. When the lens or the camera module including the lens and the image sensor tilts or moves for an OIS, it is necessary to additionally secure a space for tilting or moving around the lens or the camera module.

Meanwhile, an actuator for an OIS may be disposed around the lens. In this case, the actuator for an OIS may include actuators in charge of X-axis tilting and Y-axis tilting (i.e., an X-axis and a Y-axis perpendicular to a Z-axis which is an optical axis) tiling.

However, according to the needs of ultra-slim and ultra-small camera modules, there is a large space constraint for arranging the actuator for an OIS, and it may be difficult to secure a sufficient space for an OIS where the lens or the camera module including the lens and the image sensor itself may be tilted or moved. In addition, as the camera has a higher pixel density, it is preferable that a size of the lens be increased to increase the amount of received light, and there may be a limit to increasing the size of the lens due to a space occupied by the actuator for an OIS.

In addition, when a zooming function, an AF function, and an OIS function are all included in the camera module, there is also a problem that an OIS magnet and an AF or zoom magnet are disposed close to each other to cause magnetic field interference.

In addition, there is a problem of accuracy and a driving speed for the OIS function.

### Technical Problem

The present invention is directed to providing a camera actuator for accurately performing X-axis tilting and Y-axis tilting by a magnet/coil disposed on each of side surfaces thereof.

In addition, the present invention is also directed to providing a camera actuator having improved driving efficiency by adjusting a position of a tilting guide part.

In addition, the present invention is also directed to providing a camera actuator applicable to ultra-slim, ultra-small, and high-resolution cameras.

The object of embodiments is not limited thereto and may also include objects or effects that may be identified from the configurations or embodiments to be described below.

### Technical Solution

A camera actuator according to an embodiment of the present invention includes a housing, a mover disposed in the housing and including an optical member, a tilting guide part configured to guide tilting of the mover, and a driving unit disposed in the housing and configured to drive the mover, wherein the driving unit includes a first magnet and a third-first magnet disposed on one surface of the mover, and a second magnet and a third-second magnet disposed on the other surface opposite to the one surface, and the first magnet and the second magnet are closer to the tilting guide part than the third-first magnet and the third-second magnet are and have smaller areas than the third-first magnet and the third-second magnet.

The first magnet and the second magnet may correspond to each other, and the third-first magnet and the third-second magnet may correspond to each other.

The first magnet may include a first-first magnet area and a first-second magnet area having different polarities, the second magnet may include a second-first magnet area and a second-second magnet area having different polarities, the third-first magnet may include a third-first magnet area and a third-second magnet area having different polarities, and the third-second magnet may include a third-third magnet area and a third-fourth magnet area having different polarities.

A first polarity orientation may differ from a second polarity orientation, the first polarity orientation may be an orientation from the third-first magnet area to the third-second magnet area or an orientation from the third-third magnet area to the third-fourth magnet area, and the second polarity orientation may be an orientation from the first-first magnet area to the first-second magnet area or an orientation from the second-first magnet area to the second-second magnet area.

The first-first magnet area may have the same polarity as any one of the second-first magnet area and the second-second magnet area, and the first-second magnet area may have the same polarity as the other of the second-first magnet area and the second-second magnet area.

A length of the first magnet in an optical axis direction may differ from a length of the third-first magnet or the third-second magnet in the optical axis direction.

A length of the first magnet in the optical axis direction may be the same as a length of the second magnet in the optical axis direction.

The driving unit may include a driving coil including a first coil facing the first magnet, a second coil facing the second magnet, a third-first coil facing the third-first magnet, and a third-second coil facing the third-second magnet.

A length of the first coil in an optical axis direction may differ from a length of the first coil in a vertical direction.

A length of the third-first coil in an optical axis direction may differ from a length of the third-first coil in a vertical direction.

A length of the first coil in an optical axis direction may be smaller than a length of the third-first coil in the optical axis direction.

The first coil and the third-first coil may at least partially overlap in the optical axis direction, and the second coil and the third-second coil may at least partially overlap in the optical axis direction.

One end of the first coil and one end of the second coil may have the same node, and the other end of the first coil and the other end of the second coil may have the same node.

The first coil and the third-first coil may at least partially overlap in the optical axis direction, and the second coil and the third-second coil may at least partially overlap in the optical axis direction.

At least a portion of the tilting guide part may overlap the first coil or the second coil in a horizontal direction.

The driving unit may include a Hall sensor unit including a first Hall sensor disposed in the first coil, a second Hall sensor disposed in the second coil, a third-first Hall sensor disposed in the third-first coil, and a third-second Hall sensor disposed in the third-second coil.

Lengths of the first Hall sensor and the second Hall sensor in the optical axis direction may differ from lengths of the third-first Hall sensor and the third-second Hall sensor in the optical axis direction.

The first Hall sensor and the third-first Hall sensor may at least partially overlap in the optical axis direction.

### Advantageous Effects

According to the present invention, it is possible to implement a camera actuator for accurately performing X-axis tilting and Y-axis tilting by a magnet/coil disposed on each of side surfaces thereof.

In addition, it is possible to implement a camera actuator having improved driving efficiency by adjusting a position of a tilting guide part.

In addition, it is possible to provide a camera actuator applicable to ultra-slim, ultra-small, and high-resolution cameras. In particular, it is possible to effectively arrange an optical image stabilizer (OIS) actuator even without increasing the overall size of a camera module.

In addition, it is possible to implement a precise OIS function by not causing magnetic field interference between the X-axis tilting and the Y-axis tilting, implementing an X-axis tilting and a Y-axis tilting with a stable structure, and not causing magnetic field interference with an AF or a zooming actuator.

According to the embodiments of the present invention, it is possible to sufficiently secure an amount of light by resolving a size limit of a lens and implement an OIS with low power consumption.

Various and beneficial advantages and effects of the present invention are not limited to the above-described contents and will be more readily understood in a process of describing specific embodiments of the present invention.

### DESCRIPTION OF DRAWINGS

FIG. 1 is a perspective view of a camera module according to an embodiment.

FIG. 2 is an exploded perspective view of the camera module according to the embodiment.

FIG. 3 is a cross-sectional view along line A-A′ in FIG. 1.

FIG. 4 is a perspective view of a first camera actuator according to the embodiment.

FIG. 5 is an exploded perspective view of the first camera actuator according to the embodiment.

FIG. 6A is a perspective view of a first housing of the first camera actuator according to the embodiment.

FIG. 6B is a perspective view in a different direction from FIG. 6A.

FIG. 6C is a front view of the first housing of the first camera actuator according to the embodiment.

FIG. 7 is a perspective view of an optical member of the first camera actuator according to the embodiment.

FIG. 8A is a perspective view of a holder of the first camera actuator according to the embodiment.

FIG. 8B is a bottom view of the holder of the first camera actuator according to the embodiment.

FIG. 8C is a front view of the holder of the first camera actuator according to the embodiment.

FIG. 8D is a rear view of a fastening member of the first camera actuator according to the embodiment.

FIG. 8E is a bottom view of the fastening member of the first camera actuator according to the embodiment.

FIG. 9A is a perspective view of a tilting guide part of the first camera actuator according to the embodiment.

FIG. 9B is a perspective view in a different direction from FIG. 9A.

FIG. 9C is a cross-sectional view along line F-F′ in FIG. 9B.

FIG. 10 is a view of a first driving unit of the first camera actuator according to the embodiment.

FIG. 11A is a perspective view of the first camera actuator according to the embodiment.

FIG. 11B is a cross-sectional view along line P-P′ in FIG. 11A.

FIG. 11C is an enlarged view of portion K1 in FIG. 11B.

FIG. 11D is an enlarged view of portion K2 in FIG. 11B.

FIG. 11E is a cross-sectional view along line Q-Q′ in FIG. 11A.

FIG. 12A is a perspective view of the first camera actuator according to the embodiment.

FIG. 12B is a cross-sectional view along line S-S′ in FIG. 12A.

FIG. 12C is an exemplary view of the movement of the first camera actuator illustrated in FIG. 12B.

FIG. 13A is a cross-sectional view along line R-R′ in FIG. 12A.

FIG. 13B is an exemplary view of the movement of the first camera actuator illustrated in FIG. 13A.

FIG. 14A is a view of one sides of a holder and a driving unit according to the embodiment.

FIG. 14B is a view of the other sides of the holder and the driving unit according to the embodiment.

FIG. 14C is a view of another example of the holder, a tilting guide part, and the driving unit according to the embodiment.

FIG. 15A is a perspective view of a holder, a tilting guide part, and a driving unit according to another embodiment.

FIG. 15B is another perspective view of the holder, the tilting guide part, and the driving unit according to another embodiment.

FIG. 15C is a view of another example of the holder, the tilting guide part, and the driving unit according to another embodiment.

FIG. 16A is a perspective view of a holder, a tilting guide part, and a driving unit according to still another embodiment.

FIG. 16B is another perspective view of the holder, the tilting guide part, and the driving unit according to still another embodiment.

FIG. 16C is a view of another example of the holder, the tilting guide part, and the driving unit according to still another embodiment.

FIG. 17A is a perspective view of a holder, a tilting guide part, and a driving unit according to a modified example.

FIG. 17B is another perspective view of the holder, the tilting guide part, and the driving unit according to the modified example.

FIG. 17C is a view of another example of the holder, the tilting guide part, and the driving unit according to the modified example.

FIG. 18 is a perspective view of a second camera actuator according to the embodiment.

FIG. 19 is an exploded perspective view of the second camera actuator according to the embodiment.

FIG. 20 is a cross-sectional view along line D-D′ in FIG. 18.

FIG. 21 is a cross-sectional view along line E-E′ in FIG. 18.

FIG. 22 is a perspective view of a mobile terminal to which the camera module according to the embodiment is applied.

FIG. 23 is a perspective view of a vehicle to which the camera module according to the embodiment is applied.

### MODES OF THE INVENTION

Since the present invention may have various changes and various embodiments, specific embodiments are illustrated and described in the accompanying drawings. However, it should be understood that it is not intended to limit specific embodiments, and it should be understood to include all modifications, equivalents, and substitutes included in the spirit and scope of the present invention.

Terms including ordinal numbers such as second or first may be used to describe various components, but the components are not limited by the terms. The terms are used only for the purpose of distinguishing one component from another. For example, a second component may be referred to as a first component, and similarly, the first component may also be referred to as the second component without departing from the scope of the present invention. The term “and/or” includes a combination of a plurality of related listed items or any of the plurality of related listed items.

When a first component is described as being “connected” or “coupled” to a second component, it should be understood that the first component may be directly connected or coupled to the second component or a third component may be present therebetween. On the other hand, when the first component is described as being “directly connected” or “directly coupled” to the second component, it should be understood that the third component is not present therebetween.

The terms used in the application are only used to describe specific embodiments and are not intended to limit the present invention. The singular expression includes the plural expression unless the context clearly dictates otherwise. In the application, it should be understood that terms “comprise” and “have” are intended to specify that a feature, a number, a step, an operation, a component, a part, or a combination thereof described in the specification is present, but do not preclude the possibility of the presence or addition of one or more other features, numbers, steps, operations, components, parts, or combinations thereof.

Unless defined otherwise, all terms used herein, including technical or scientific terms, have the same meaning as commonly understood by those of ordinary skill in the art to which the present invention pertains. Terms such as those defined in a commonly used dictionary should be construed as having a meaning consistent with the meaning in the context of the related art and should not be construed in an ideal or excessively formal meaning unless explicitly defined in the application.

Hereinafter, embodiments will be described in detail with reference to the accompanying drawings, and the same or corresponding components are denoted by the same reference numeral regardless of the reference numerals, and overlapping descriptions thereof will be omitted.

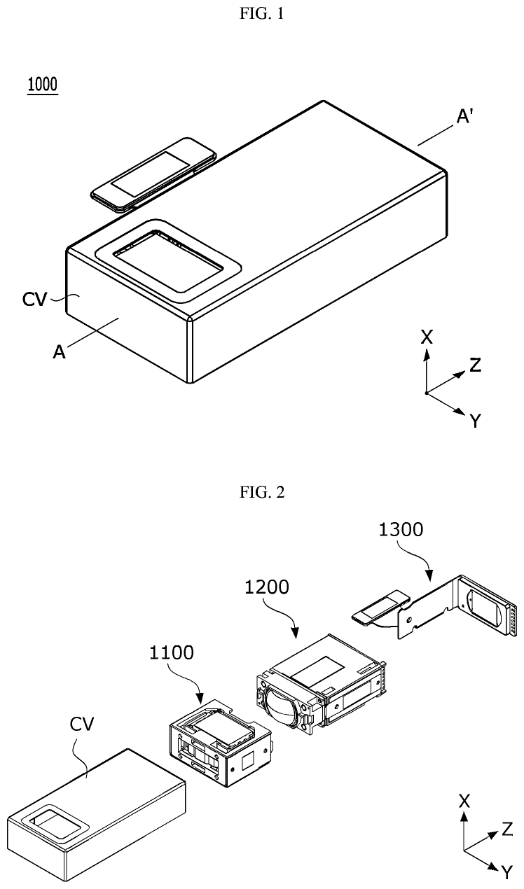

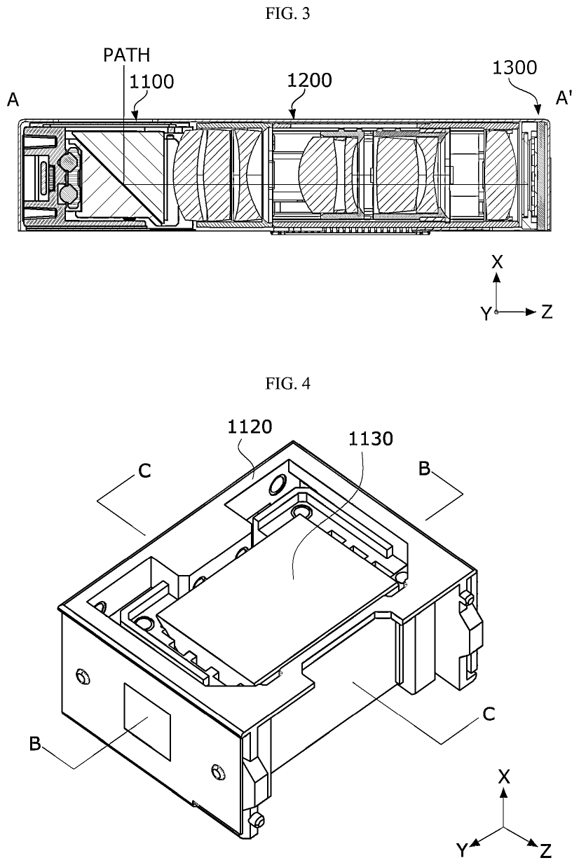

FIG. 1 is a perspective view of a camera module according to an embodiment, FIG. 2 is an exploded perspective view of the camera module according to the embodiment, and FIG. 3 is a cross-sectional view along line A-A′ in FIG. 1.

Referring to FIGS. 1 and 2, a camera module 1000 according to the embodiment may include a cover CV, a first camera actuator 1100, a second camera actuator 1200, and a circuit board 1300. Here, the first camera actuator 1100 may be used interchangeably with “first actuator,” and the second camera actuator 1200 may be used interchangeably with “second actuator.”

The cover CV may cover the first camera actuator 1100 and the second camera actuator 1200. It is possible to increase a coupling strength between the first camera actuator 1100 and the second camera actuator 1200 by the cover CV.

Furthermore, the cover CV may be made of a material that blocks electromagnetic waves. Therefore, it is possible to easily protect the first camera actuator 1100 and the second camera actuator 1200 in the cover CV.

In addition, the first camera actuator 1100 may be an optical image stabilizer (OIS) actuator. For example, the first camera actuator 1100 may move an optical member in a direction perpendicular to an optical axis.

The first camera actuator 1100 may include a fixed focal length lens disposed in a predetermined barrel (not illustrated). The fixed focal length lens may be referred to as “single focal length lens” or “single lens.”

The first camera actuator 1100 may change an optical path. In an embodiment, the first camera actuator 1100 may vertically change the optical path through an internal optical member (e.g., a prism or a mirror). With this configuration, even when a thickness of a mobile terminal decreases, a lens that is larger than the thickness of the mobile terminal is disposed in the mobile terminal so that zooming, auto focusing (AF), and OIS functions may be performed through the change in the optical path.

However, the present invention is not limited thereto, and the first camera actuator 1100 may change the optical path vertically or at a predetermined angle multiple times.

The second camera actuator 1200 may be disposed at a rear end of the first camera actuator 1100. The second camera actuator 1200 may be coupled to the first camera actuator 1100. In addition, the mutual coupling may be performed by any of various methods.

In addition, the second camera actuator 1200 may be a zooming actuator or an AF actuator. For example, the second camera actuator 1200 may support one or more lenses and perform an AF function or a zooming function by moving the lenses according to a predetermined control signal of a control unit.

In addition, one lens or a plurality of lenses may independently or separately move in an optical axis direction.

The circuit board 1300 may be disposed at a rear end of the second camera actuator 1200. The circuit board 1300 may be electrically connected to the second camera actuator 1200 and the first camera actuator 1100. In addition, a plurality of circuit boards 1300 may be provided. The circuit board 1300 may include an image sensor and the like and may include a connector electrically connected to another external camera module or a processor of another external terminal.

In addition, the circuit board 1300 may further include a protective member (e.g., a glass) for protecting the image sensor and a filter.

A camera module according to the embodiment may be formed of one camera module or a plurality of camera modules. For example, the plurality of camera modules may include a first camera module and a second camera module.

In addition, the first camera module may include one actuator or a plurality of actuators. For example, the first camera module may include the first camera actuator 1100 and the second camera actuator 1200.

In addition, the second camera module may include an actuator (not illustrated) disposed in a predetermined housing (not illustrated) and capable of driving a lens unit. The actuator may be a voice coil motor, a micro actuator, a silicon actuator, and the like and applied in various methods such as an electrostatic method, a thermal method, a bimorph method, and an electrostatic force method, but the present invention is not limited thereto. In addition, in the specification, the camera actuator may be referred to as “actuator,” or the like. In addition, the camera module formed of the plurality of camera modules may be mounted in various electronic devices such as a mobile terminal. For example, the electronic device may include all smartphones, mobile terminals (e.g., phones), mobile terminals, and the like.

Referring to FIG. 3, the camera module according to the embodiment may include the first camera actuator 1100 for performing the OIS function and the second camera actuator 1200 for performing the zooming function and the AF function.

Light may enter the camera module or the first camera actuator through an opening area positioned in an upper surface of the first camera actuator 1100. In other words, the light may enter the first camera actuator 1100 in an optical axis direction (e.g., an X-axis direction), and the optical path may be vertically (e.g., a Z-axis direction) through the optical member. In addition, the optical axis direction (Z-axis direction) may correspond to a moving direction of light reflected by the optical member, and the following description will be made based on this. In addition, the light may pass through the second camera actuator 1200 and enter an image sensor IS positioned at one end of the second camera actuator 1200 (PATH). In other words, the optical axis may be changed by the optical member.

In the specification, a lower surface refers to one side in a first direction. In addition, the first direction is the X-axis direction in the drawings and may be used interchangeably with a second axis direction, etc. A second direction is a Y-axis direction in the drawings and may be used interchangeably with a first axis direction or the like. The second direction is a direction perpendicular to the first direction. In addition, a third direction is the Z-axis direction in the drawings and may be used interchangeably with a third axis direction or the like. In addition, the third direction is perpendicular to both the first direction and the second direction. Here, the third direction (Z-axis direction) corresponds to the optical axis direction, and the first direction (X-axis direction) and the second direction (Y-axis direction) are directions perpendicular to the optical axis, and the optical path may be tilted by the second camera actuator. In addition, hereinafter, the optical axis direction is the third direction (Z-axis direction) in the description of the first camera actuator 1100, and the following description will be made based on this.

In addition, in this specification, the term “inward” may be a direction from the cover CV toward the first camera actuator, and the term “outward” may be a direction opposite to the “inward.” In other words, the first camera actuator and the second camera actuator may be positioned inside the cover CV, and the cover CV may be positioned outside the first camera actuator or the second camera actuator.

In addition, with this configuration, the camera module according to the embodiment may resolve the spatial limits of the first camera actuator and the second camera actuator by changing the optical path. In other words, the camera module according to the embodiment may extend the optical path in response to the change in the optical path while minimizing the thickness of the camera module. Furthermore, it should be understood that the second camera actuator may provide a high range of magnification by controlling a focus or the like in the extended optical path.

In addition, the camera module according to the embodiment may implement an OIS by controlling the optical path through the first camera actuator, thereby minimizing the occurrence of a decentering or tilting phenomenon and providing the best optical characteristics.

Furthermore, the second camera actuator 1200 may include an optical system and a lens driving unit. For example, at least one of a first lens assembly, a second lens assembly, a third lens assembly, and a guide pin may be disposed in the second camera actuator 1200.

In addition, the second camera actuator 1200 may include a coil and a magnet to perform a high-magnification zooming function.

For example, although the first lens assembly and the second lens assembly may be moving lenses that move through the coil, the magnet, and the guide pin, and the third lens assembly may be a fixed lens, the present invention is not limited thereto. For example, the third lens assembly may perform a function for a focator by which light forms an image at a specific position, and the first lens assembly may perform a function for a variator for re-forming an image formed by the third lens assembly, which is the focator, at another position. Meanwhile, the first lens assembly may be in a state in which a magnification change is large because a distance to a subject or an image distance is greatly changed, and the first lens assembly, which is the variator, may play an important role in a focal length or magnification change of the optical system. Meanwhile, imaging points of an image formed by the first lens assembly, which is the variator, may be slightly different depending on a position. Therefore, the second lens assembly may perform a position compensation function for the image formed by the variator. For example, the second lens assembly may perform a function for a compensator for accurately forming an image at an actual position of the image sensor using the imaging points of the image formed by the first lens assembly which is the variator. For example, the first lens assembly and the second lens assembly may be driven by an electromagnetic force generated by the interaction between the coil and the magnet. The above description may be applied to a lens assembly to be described below. In addition, the first lens assembly to the third lens assembly may move in the optical axis direction, that is, in the third direction. In addition, the first lens assembly to the third lens assembly may move in the third direction independently or dependently.

Meanwhile, when the OIS actuator and the AF or zooming actuator are disposed according to the embodiment of the present invention, it is possible to inhibit the magnetic field interference of an AF or zoom magnet and an OIS magnet when an OIS is driven. Since a first driving magnet of the first camera actuator 1100 is disposed separately from the second camera actuator 1200, it is possible to inhibit the magnetic field interference between the first camera actuator 1100 and the second camera actuator 1200. In the specification, an OIS may be used interchangeably with terms such as hand shaking correction, optical image stabilization, optical image correction, or shaking correction.

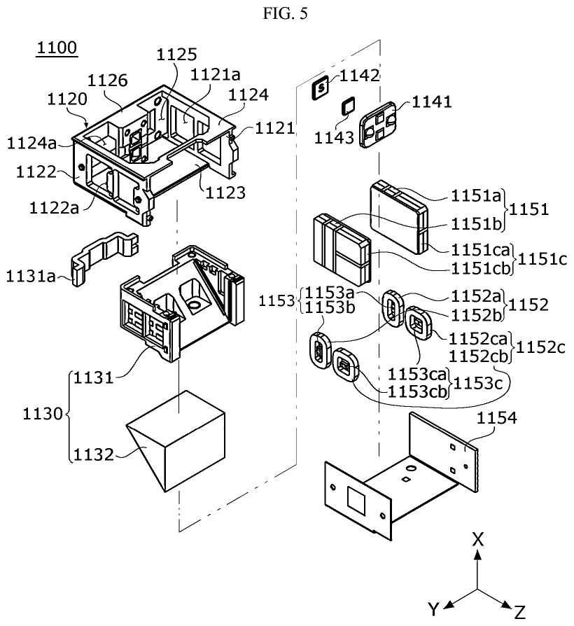

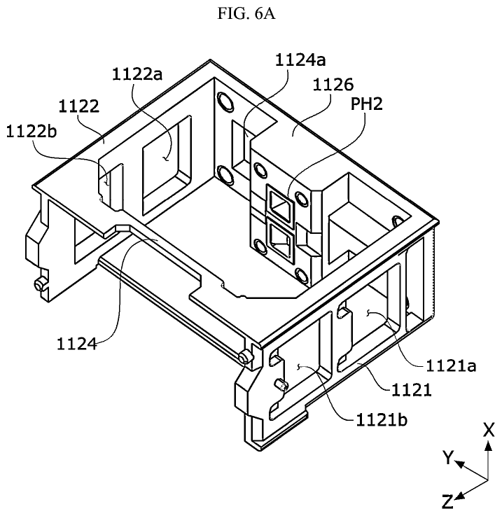

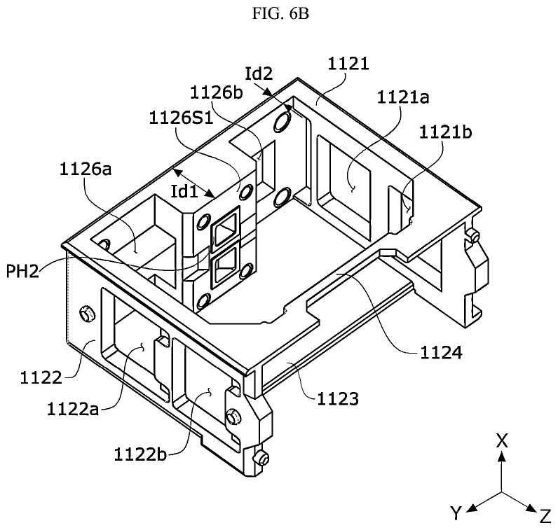

FIG. 4 is a perspective view of a first camera actuator according to the embodiment, and FIG. 5 is an exploded perspective view of the first camera actuator according to the embodiment.

Referring to FIGS. 4 and 5, the first camera actuator 1100 according to the embodiment includes a first housing 1120, a mover 1130, a rotating unit 1140, a first driving unit 1150, and a fastening member 1131a.

The mover 1130 may include a holder 1131 and an optical member 1132 seated on the holder 1131. Furthermore, the mover 1130 may include the fastening member 1131a and may be integrally rotated by being coupled to the fastening member 1131a.

In addition, the rotating unit 1140 may include a tilting guide part 1141 and a first magnetic part 1142 and a second magnetic part 1143 having different polarities to press the tilting guide part 1141.

In addition, the first driving unit 1150 includes a first driving magnet 1151, a first driving coil 1152, a Hall sensor unit 1153, a first board unit 1154, and a yoke unit (not illustrated).

First, the first camera actuator 1100 may include a shield can (not illustrated). The shield can (not illustrated) may be positioned at an outermost side of the first camera actuator 1100 and positioned to surround the rotating unit 1140 and the first driving unit 1150, which will be described below.

The shield can (not illustrated) can block or attenuate electromagnetic waves generated from the outside. In other words, the shield can (not illustrated) can reduce the occurrence of malfunction in the rotating unit 1140 or the first driving unit 1150.

The first housing 1120 may be positioned inside the shield can (not illustrated). When there is no shield can, the first housing 1120 may be positioned at the outermost side of the first camera actuator.

In addition, the first housing 1120 may be positioned inside the first board unit 1154 to be described below. The first housing 1120 may be fastened by being fitted into or engaged with the shield can (not illustrated).

The first housing 1120 may include a first housing side portion 1121, a second housing side portion 1122, a third housing side portion 1123, a fourth housing side portion 1124, and a fifth housing side portion 1126. A detailed description thereof will be made below.

In particular, the fifth housing side portion 1126 may be formed integrally with or separately from the first housing 1120. In the specification, the following description will be made based on that the fifth housing side portion 1126 is formed integrally with the first housing 1120. In addition, the fastening member 1131a may pass through the fifth housing side portion 1126. A description thereof will be made below.

The mover 1130 may include the holder 1131 and the optical member 1132 seated on the holder 1131.

The holder 1131 may be seated in an accommodating part 1125 of the first housing 1120. The holder 1131 may include a first holder outer surface to a fourth holder outer surface respectively corresponding to the first housing side portion 1121, the second housing side portion 1122, the third housing side portion 1123, and the fifth housing side portion 1126. For example, each of the first holder outer surface to the fourth holder outer surface may correspond to or face one of inner surfaces of the first housing side portion 1121, the second housing side portion 1122, the third housing side portion 1123, and the fifth housing side portion 1126.

In addition, the holder 1131 may include the fastening member 1131a disposed in a fourth seating groove. A detailed description thereof will be made below.

The optical member 1132 may be seated on the holder 1131. To this end, the holder 1131 may have a seating surface, and the seating surface may be formed by an accommodating groove. In an embodiment, the optical member 1132 may be formed of any of various reflective members. For example, the optical member 1132 may be formed of a mirror or a prism. Hereinafter, it is illustrated that the optical member 1132 is the prism, but may be formed of a plurality of lenses as in the above-described embodiment. Alternatively, the optical member 1132 may be formed of the plurality of lenses and the prism or the mirror. In addition, the optical member 1132 may include a reflector disposed therein. However, the present invention is not limited thereto.

In addition, the optical member 1132 may reflect light reflected from the outside (e.g., an object) into the camera module. In other words, the optical member 1132 can resolve spatial limits of the first camera actuator and the second camera actuator by changing the path of the reflected light. Therefore, it should be understood that the camera module may provide a high range of magnification by extending the optical path while minimizing a thickness thereof.

The fastening member 1131a may be coupled to the holder 1131. The fastening member 1131a may be disposed outside the holder 1131, and at least a portion thereof may be disposed inside the housing. In addition, the fastening member 1131a may be seated in an additional groove positioned in an area other than the fourth seating groove of the fourth holder outer surface of the holder 1131. In this case, the fastening member 1131a and the holder 1131 may be coupled through a bonding member. For example, the bonding member may be made of a material such as an epoxy. Therefore, the fastening member 1131a may be coupled to the holder 1131, and at least a portion of the fifth housing side portion 1126 may be positioned between the fastening member 1131a and the holder 1131. For example, the at least a portion of the fifth housing side portion 1126 may pass through a space formed between the fastening member 1131a and the holder 1131.

In addition, the fastening member 1131a may have a structure separated from the holder 1131. With this configuration, the first camera actuator may be easily assembled as will be described below. Alternatively, although the fastening member 1131a may be integrally formed with the holder 1131, the following description will be made based on the separated structure.

The rotating unit 1140 includes the tilting guide part 1141, and the first magnetic part 1142 and the second magnetic part 1143 having different polarities to press the tilting guide part 1141.

The tilting guide part 1141 may be coupled to the mover 1130 and the first housing 1120. Specifically, the tilting guide part 1141 may be disposed between the holder 1131 and the fifth housing side portion 1126. Therefore, the tilting guide part 1141 may be coupled to the mover 1130 of the holder 1131 and the first housing 1120. However, unlike the above description, in the embodiment, the tilting guide part 1141 may be disposed between the fifth housing side portion 1126 and the holder 1131. Specifically, the tilting guide part 1141 may be positioned between the fifth housing side portion 1126 and the fourth seating groove of the holder 1131.

The fastening member 1131a, the fifth housing side portion 1126, the tilting guide part 1141, and the holder 1131 may be sequentially disposed in the third direction (Z-axis direction) (based on an outermost surface). In addition, the first magnetic part 1142 and the second magnetic part 1143 may be respectively seated in a first groove formed in the fastening member 1131a and a second groove formed in the fifth housing side portion 1126. In the embodiment, the first groove and the second groove may have different positions from first and second grooves in other embodiments. However, the first groove is positioned in the fastening member 1131a and moves integrally with the holder, and the second groove is positioned on the fifth housing side portion 1126 in correspondence to the first groove and is coupled to the first housing 1120. Therefore, the following description will be made by interchangeably using these terms. In addition, the second groove may be positioned between the first groove and the tilting guide part 1141.

In addition, the tilting guide part 1141 may be disposed adjacent to the optical axis. Therefore, the actuator according to the embodiment may easily change the optical path according to the first-axis tilting and second-axis tilting to be described below.

The tilting guide part 1141 may include first protruding portions disposed to be spaced apart from each other in the first direction (X-axis direction) and second protruding portions disposed to be spaced apart from each other in the second direction (Y-axis direction). In addition, the first protruding portion and the second protruding portion may protrude in opposite directions. A detailed description thereof will be made below.

In addition, as described above, the first magnetic part 1142 may be positioned in the fastening member 1131a. In addition, the second magnetic part 1143 may be positioned in the fifth housing side portion 1126.

The first magnetic part 1142 and the second magnetic part 1143 may have the same polarity. For example, the first magnetic part 1142 may be an N pole magnet, and the second magnetic part 1143 may be an N pole magnet. Alternatively, conversely, the first magnetic part 1142 may be an S pole magnet, and the second magnetic part 1143 may be an S pole magnet.

For example, a second pole surface of the second magnetic part 1143 and a first pole surface of the first magnetic part 1142 facing the second pole surface may have the same polarity. In other words, the first magnetic part 1142 and the second magnetic part 1143 may generate a repulsive force, and to this end, may have various materials, functions, and the like.

For example, the first magnetic part 1142 and the second magnetic part 1143 may generate the repulsive force therebetween due to the above-described polarities. With this configuration, the above-described repulsive force may be applied to the fastening member 1131a or the holder 1131 coupled to the first magnetic part 1142 or the fifth housing side portion 1126 or the first housing 1120 coupled to the second magnetic part 1143. In this case, the repulsive force applied to the fastening member 1131a may be transmitted to the holder 1131 coupled to the fastening member 1131a. Therefore, the tilting guide part 1141 disposed between the fastening member 1131a and the fifth housing side portion 1126 may be in close contact with each other and pressed by the repulsive force. In other words, the repulsive force may hold the position of the tilting guide part 1141 between the holder 1131 and the first housing 1120 (or the fifth housing side portion 1126). With this configuration, it is possible to hold the position of the tilting guide part between the mover 1130 and the first housing 1120 even during an X-axis tilting or a Y-axis tilting. In addition, the tilting guide part may be in close contact with the fifth housing side portion 1126 and the holder 1131 by the repulsive force generated between the second magnetic part 1143 and the first magnetic part 1142.

The first driving unit 1150 includes the first driving magnet 1151, the first driving coil 1152, the Hall sensor unit 1153 (or the first Hall sensor unit), the first board unit 1154, and the yoke unit (not illustrated). A description thereof will be made below.

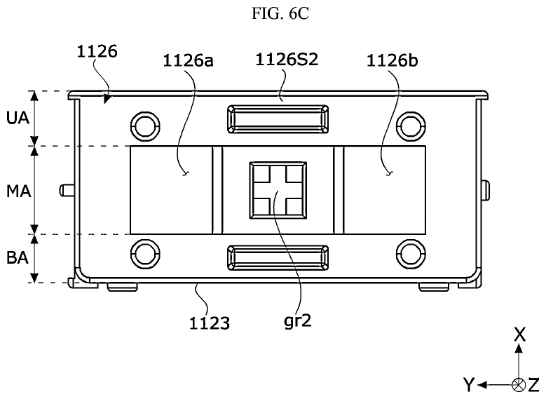

FIG. 6A is a perspective view of a first housing of the first camera actuator according to the embodiment, FIG. 6B is a perspective view in a different direction from FIG. 6A, and FIG. 6C is a front view of the first housing of the first camera actuator according to the embodiment.

Referring to FIGS. 6A to 6C, the first housing 1120 according to the embodiment may include the first housing side portion 1121 to the fifth housing side portion 1126. The first housing side portion 1121 and the second housing side portion 1122 may be disposed to face each other. In addition, the third housing side portion 1123 and the fourth housing side portion 1124 may be disposed to face each other.

In addition, the third housing side portion 1123 and the fourth housing side portion 1124 may be disposed between the first housing side portion 1121 and the second housing side portion 1122.

The third housing side portion 1123 and the fourth housing side portion 1124 may be in contact with the first housing side portion 1121, the second housing side portion 1122, and the fifth housing side portion 1126. In addition, the third housing side portion 1123 may be a lower surface of the first housing 1120. In addition, the fourth housing side portion 1124 may be an upper surface of the first housing 1120. In addition, the above-described contents may also be applied to a description of a direction in the same manner.

In addition, the first housing side portion 1121 may include a first housing hole 1121a. A first coil to be described below may be positioned in the first housing hole 1121a. In addition, the first housing side portion 1121 may include a third-first housing hole 1121b. A third-first coil may be positioned in the third-first housing hole 1121b. The third-first housing hole 1121b may be disposed to be spaced apart from the first housing hole 1121a.

In addition, the second housing side portion 1122 may include a second housing hole 1122a. In addition, a second coil to be described below may be positioned in the second housing hole 1122a. In addition, the second housing side portion 1122 may include a third-second housing hole 1122b. A third-second coil may be positioned in the third-second housing hole 1122b. The third-second housing hole 1122b may be disposed to be spaced apart from the second housing hole 1122a.

In addition, the first housing side portion 1121 and the second housing side portion 1122 may be side surfaces of the first housing 1120.

The first coil and the second coil may be coupled to a first board unit. In an embodiment, the first coil and the second coil may be electrically connected to the first board unit so that a current may flow therebetween. The current is an element of an electromagnetic force capable of tilting the first camera actuator about the X-axis or the Y-axis (X-axis in the embodiment). In addition, the third-first coil and the third-second coil may be coupled to the first board unit. In an embodiment, the third-first coil and the third-second coil may be electrically connected to the first board unit so that a current may flow therethrough. The current is an element of an electromagnetic force capable of tilting the first camera actuator with respect to the X-axis or the Y-axis (Y-axis in the embodiment).

In addition, the third housing side portion 1123 may be positioned between the first housing side portion 1121 and the second housing side portion 1122.

The fifth housing side portion 1126 may be seated between the first housing side portion 1121 to the fourth housing side portion 1124. Therefore, the fifth housing side portion 1126 may be positioned on the third housing side portion 1123. For example, the fifth housing side portion 1126 may be positioned at one side. The fifth housing side portion 1126 and the holder may be sequentially positioned in the third direction.

The fourth housing side portion 1124 may be disposed between the first housing side portion 1121 and the second housing side portion 1122 and may be in contact with the first housing side portion 1121, the second housing side portion 1122, and the third housing side portion 1123.

In addition, the fourth housing side portion 1124 may include a fourth housing hole 1124a. The fourth housing hole 1124a may be positioned above the optical member. Therefore, light may enter the optical member after passing through the fourth housing hole 1124a.

In addition, the first housing 1120 may include the accommodating part 1125 formed by the first housing side portion 1121 to the fifth housing side portion 1126. The fastening member, the tilting guide part, the mover, and the like may be positioned in the accommodating part 1125 as components.

In an embodiment, the fifth housing side portion 1126 may be positioned between the first housing side portion 1121 and the second housing side portion 1122. In addition, the fifth housing side portion 1126 may be positioned between the third housing side portion 1123 and the fourth housing side portion 1124.

In addition, the fifth housing side portion 1126 may be positioned on the third housing side portion 1123 and may be in contact with the first housing side portion 1121 to the third housing side portion 1123.

In addition, the fifth housing side portion 1126 includes a second protrusion groove in which a second protruding portion of the tilting guide part is seated. The second protrusion groove PH2 may be positioned in an inner surface 1126S1 of the fifth housing side portion 1126. The inner surface 1126S1 of the fifth housing side portion 1126 may protrude inward between through-holes 1126a and 1126b of the fifth housing side portion 1126. Therefore, in the fifth housing side portion 1126, the protruding portion (e.g., the second protruding portion) of the tilting guide part is disposed adjacent to the prism in the fourth seating groove so that the protrusion, which is a reference axis of tilting, is disposed adjacent to the center of gravity of the mover 1130. Therefore, when the holder is tilted, a moment for moving the mover 1130 for tilting can be minimized. Therefore, it is possible to minimize the current consumption for driving the coil, thereby reducing the power consumption of the camera actuator.

In addition, the fifth housing side portion 1126 may include the through-holes 1126a and 1126b. The through-hole may be provided as a plurality of through-holes and may include the first through-hole 1126a and the second through-hole 1126b.

First and second extensions of the fastening member, which will be described below, may respectively pass through the first through-hole 1126a and the second through-hole 1126b. Therefore, the fastening member and the fifth housing side portion may be coupled. In other words, the first housing and the mover may be coupled.

The second protrusion groove PH2 may be positioned between the first through-hole 1126a and the second through-hole 1126b. With this configuration, it is possible to increase a coupling strength between the tilting guide part and the fifth housing side portion 1126, thereby inhibiting a degradation in tilting accuracy caused by the movement of the tilting guide part within the first housing.

In addition, the second groove gr2 may be positioned in an outer surface 1126S2 of the fifth housing side portion 1126. The second magnetic part may be seated in the second groove gr2. In addition, the outer surface 1126S2 of the fifth housing side portion 1126 may face an inner surface of the fastening member or a member base unit. Furthermore, the first magnetic part seated on the fastening member and the second magnetic part of the fifth housing side portion 1126 may face each other and generate the above-described repulsive force. Therefore, since the fifth housing side portion 1126 presses the tilting guide part inward or the holder by the repulsive force, the mover may be spaced a predetermined distance from the third housing side portion in the first housing even without the application of a current to the coil. In other words, a coupling strength between the mover, the housing, and the tilting guide part may be maintained.

In addition, a plurality of other grooves may be positioned in the outer surface 1126S2 of the fifth housing side portion 1126. This is intended to easily manufacture the first housing in a process.

In addition, when the fifth housing side portion 1126 is integrally formed with the first housing 1120, it is possible to increase the coupling strength between the fifth housing side portion 1126 and the first housing 1120, thereby improving the reliability of the camera actuator. In addition, when the fifth housing side portion 1126 is formed separately from the first housing 1120, it is possible to increase the ease of assembly and manufacture of the fifth housing side portion 1126 and the first housing 1120.

In addition, in an embodiment, the fifth housing side portion 1126 may include the first through-hole 1126a and the second through-hole 1126b. In addition, the first through-hole 1126a and the second through-hole 1126b may be disposed side by side in the second direction (Y-axis direction) and may overlap each other.

In addition, the fifth housing side portion 1126 may include an upper member UA positioned above the first through-hole 1126a and the second through-hole 1126b and a lower member BA positioned under the first through-hole 1126a and the second through-hole 1126b. Therefore, the first through-hole 1126a and the second through-hole 1126b may be positioned in the middle of the fifth housing side portion 1126. In other words, the fifth housing side portion 1126 may include a connection member MA positioned on side portions of the first through-hole 1126a and the second through-hole 1126b. In other words, the upper member UA and the lower member BA may be connected through the connection member MA. In addition, a plurality of lower members BA may be formed to form the first and second through-holes and disposed to be spaced apart from each other in the second direction (Y-axis direction).

Therefore, the fifth housing side portion 1126 may have the upper members UA to increase stiffness. For example, it is possible to further increase the stiffness of the fifth housing side portion 1126 than a case in which the upper member UA is not present. For example, in the embodiment, a unit of stiffness may be N/μm. Therefore, it is possible to improve the reliability of the first camera actuator according to the embodiment.

In addition, the fifth housing side portion 1126 may further include the first protruding portion and the second protruding portion. The first protruding portion may be in contact with the first housing side portion, and the second protruding portion may be in contact with the second housing side portion. The first protruding portion may extend from one end portion of the outer surface 1126S2 of the fifth housing side portion in the third direction (Z-axis direction). The second protruding portion may extend from the other end portion of the outer surface 1126S2 of the fifth housing side portion in the third direction (Z-axis direction). In other words, the first protruding portion and the second protruding portion may extend toward the holder.

Furthermore, the fifth housing side portion 1126 may have an inner thickness Id1 larger than an outer thickness Id2. The thickness may be a length in the third direction (Z-axis direction). With this configuration, even when the second protruding portion of the tilting guide part is seated in the second protrusion groove PH2 formed in the inner surface 1126S1 of the fifth housing side portion 1126, it is possible to suppress damage to the fifth housing side portion 1126. In other words, it is possible to improve the reliability of the camera actuator.

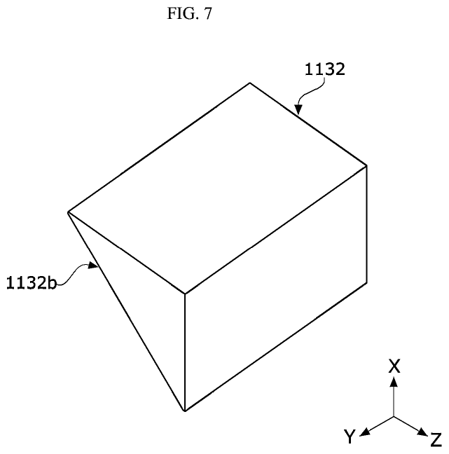

FIG. 7 is a perspective view of an optical member of the first camera actuator according to the embodiment.

The optical member 1132 may be seated on the holder. The optical member 1132 may be, for example, a prism as a reflector, but is not limited thereto as described above.

In an embodiment, the optical member 1132 may have a protruding portion (not illustrated) formed on a portion of an outer surface thereof. The optical member 1132 may be easily coupled to the holder through the protruding portion (not illustrated). In addition, the holder may be coupled to the optical member 1132 with a groove or a protrusion.

In addition, a lower surface 1132b of the optical member 1132 may be seated on the seating surface of the holder. Therefore, the lower surface 1132b of the optical member 1132 may correspond to the seating surface of the holder. In an embodiment, the lower surface 1132b may be formed as an inclined surface like the seating surface of the holder. Therefore, it is possible to inhibit the optical member 1132 from being separated from the holder due to the movement of the prism according to the movement of the holder.

In addition, a groove may be formed in the lower surface 1132b of the optical member 1132, and a bonding member may be applied to the groove, and thus the optical member 1132 may be coupled to the holder. Alternatively, the holder may be coupled to the optical member 1132 by applying the bonding member to the groove or protrusion of the holder.

In addition, as described above, the optical member 1132 may have a structure in which the light reflected from the outside (e.g., an object) may be reflected into the camera module. As in the embodiment, the optical member 1132 may be formed of a single mirror. In addition, the optical member 1132 can resolve the spatial limits of the first camera actuator and the second camera actuator by changing the path of the reflected light. Therefore, it should be understood that the camera module may provide a high range of magnification by extending the optical path while minimizing a thickness thereof. In addition, it should be understood that the camera module including the camera actuator according to the embodiment may provide a high range of magnification by extending the optical path while minimizing the thickness thereof.

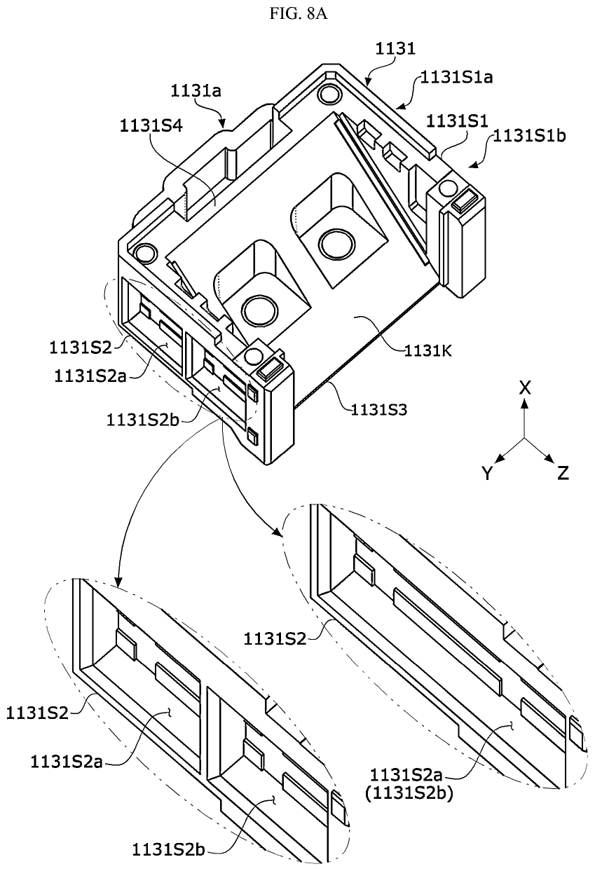

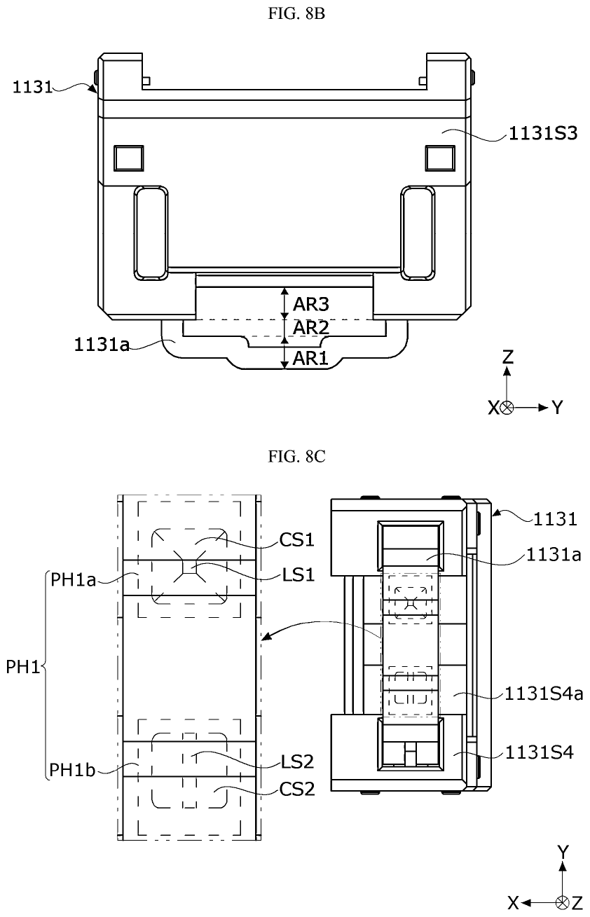

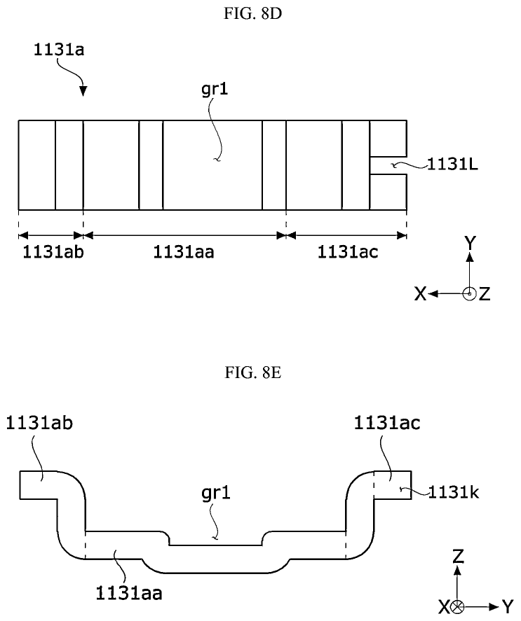

FIG. 8A is a perspective view of a holder of the first camera actuator according to the embodiment, FIG. 8B is a bottom view of the holder of the first camera actuator according to the embodiment, FIG. 8C is a front view of the holder of the first camera actuator according to the embodiment, FIG. 8D is a rear view of a fastening member of the first camera actuator according to the embodiment, and FIG. 8E is a bottom view of the fastening member of the first camera actuator according to the embodiment.

Referring to FIGS. 8A to 8E, the holder 1131 may include a seating surface 1131k on which the optical member 1132 is seated. The seating surface 1131k may be an inclined surface. In addition, the holder 1131 may include a stepped portion on the seating surface 1131k. In addition, the stepped portion of the holder 1131 may be coupled to the protruding portion (not illustrated) of the optical member 1132.

The holder 1131 may include a plurality of outer surfaces. For example, the holder 1131 may include a first holder outer surface 1131S1, a second holder outer surface 1131S2, a third holder outer surface 1131S3, and a fourth holder outer surface 1131S4.

The first holder outer surface 1131S1 may be positioned to face the second holder outer surface 1131S2. In other words, the first holder outer surface 1131S1 may be symmetrically disposed with the second holder outer surface 1131S2 with respect to the first direction (X-axis direction).

The first holder outer surface 1131S1 may be positioned to correspond to the first housing side portion. In other words, the first holder outer surface 1131S1 may be positioned to face the first housing side portion. In addition, the second holder outer surface 1131S2 may be positioned to correspond to the second housing side portion. In other words, the second holder outer surface 1131S2 may be positioned to face the second housing side portion.

In addition, the first holder outer surface 1131S1 may include a first seating groove 1131S1a. In addition, the first holder outer surface 1131S1 may include a third-first seating groove 1131S1b.

In addition, the second holder outer surface 1131S2 may include a second seating groove 1131S2a. In addition, the second holder outer surface 1131S2 may include a third-second seating groove 1131S2b.

In an embodiment, the first seating groove 1131S1a and the second seating groove 1131S2a may be symmetrically disposed with respect to the first direction (X-axis direction). In addition, the third-first seating groove 1131S1b and the third-second seating groove 1131S2b may be symmetrically disposed with respect to the first direction (X-axis direction).

In addition, the first seating groove 1131S1a and the second seating groove 1131S2a may be disposed to overlap each other in the second direction (Y-axis direction). In addition, the third-first seating groove 1131S1b and the third-second seating groove 1131S2b may be disposed to overlap each other in the second direction (Y-axis direction).

For example, the first seating groove 1131S1a and the third-first seating groove 1131S1b may be formed separately or integrally. For example, a partition wall, a member, a wing, or the like may be positioned between the first seating groove 1131S1a and the third-first seating groove 1131S1b so that the first seating groove 1131S1a and the third-first seating groove 1131S1b may be separated.

In addition, the first seating groove 1131S1a and the third-first seating groove 1131S1b may be formed as one groove. In addition, the first magnet may be seated at one side (area corresponding to the first seating groove) of the one groove. In addition, the third-first magnet may be seated at the other side (area corresponding to the third-first seating groove) of the one groove.

In addition, the second seating groove 1131S2a and the third-second seating groove 1131S2b may also be formed separately or integrally. For example, a partition wall, a member, a wing, or the like may be positioned between the second seating groove 1131S2a and the third-second seating groove 1131S2b so that the second seating groove 1131S2a and the third-second seating groove 1131S2b may be separated. In addition, the second seating groove 1131S2a and the third-second seating groove 1131S2b may be formed as one groove. Therefore, the second magnet may be seated at one side (area corresponding to the second seating groove) of the one groove. In addition, the third-second magnet may be seated at the other side (area corresponding to the third-second seating groove) of the one groove. In addition, the first magnet may be disposed in the first seating groove 1131S1a, and the second magnet may be disposed in the second seating groove 1131S2a. The first magnet and the second magnet may also be symmetrically disposed with respect to the first direction (X-axis direction).

In addition, the third-first magnet may be positioned in the third-first seating groove 1131S1b. In addition, the third-second magnet may be positioned in the third-second seating groove 1132S1b. The third-first magnet and the third-second magnet may also be symmetrically disposed with respect to the first direction (X-axis direction).

In the specification, it should be understood that the first magnet to the third-second magnet may be coupled to the housing through the yoke or the bonding member.

As described above, due to positions of the first and second seating grooves and the first and second magnets, an electromagnetic force generated by each magnet may be coaxially provided to the first holder outer surface S1131S1 and the second holder outer surface 1131S2. Likewise, due to positions of the third-first seating groove and the third-second seating groove (the third-first magnet and the third-second magnet), an electromagnetic force generated by each magnet may be coaxially provided to the first holder outer surface S1131S1 and the second holder outer surface 1131S2.

For example, an area (e.g., a portion to which the strongest electromagnetic force is applied) of the first holder outer surface S1131S1 to which the electromagnetic force is applied and an area (e.g., a portion to which the strongest electromagnetic force is applied) of the second holder outer surface S1131S1 to which the electromagnetic force is applied may be positioned on an axis parallel to the second direction (Y-axis direction). Therefore, the X-axis tilting may be accurately performed.

For example, an area (e.g., a portion having the strongest electromagnetic force) of the first holder outer surface S1231S1 to which the electromagnetic force is applied and an area (e.g., a portion having the strongest electromagnetic force) of the second holder outer surface S1231S1 to which the electromagnetic force is applied may be positioned on an axis parallel to the second direction (Y-axis direction). Therefore, the Y-axis tilting may be accurately performed.

The first magnet 1151a may be disposed in the first seating groove 1131S1a, and the second magnet 1151b may be disposed in the second seating groove 1131S2a.

In addition, the third-first magnet 1151ca may be disposed in the third-first seating groove 1131S1b. In addition, the third-second magnet 1151cb may be disposed in the third-second seating groove 1131S2b.

The third holder outer surface 1131S3 may be in contact with the first holder outer surface 1131S1 and the second holder outer surface 1131S2 and may be an outer surface extending from one sides of the first holder outer surface 1131S1 and the second holder outer surface 1131S2 in the second direction (Y-axis direction). In addition, the third holder outer surface 1131S3 may be positioned between the first holder outer surface 1131S1 and the second holder outer surface 1131S2. The third holder outer surface 1131S3 may be the lower surface of the holder 1131. In other words, the third holder outer surface 1131S3 may be positioned to face the third housing side portion.

In addition, the third holder outer surface 1131S3 may be positioned to face the third housing side portion 1123.

In an embodiment, the third-first seating groove 1131S1b and third-second seating groove 1131S2b may have a larger area than the first seating groove 1131S1a or the second seating groove 1131S2a. With this configuration, the Y-axis tilting may be performed by current control similar to that of the X-axis tilting. Furthermore, the Y-axis tilting may be easily performed by the third-first seating groove 1131S1b and the third-second seating groove 1131S2b having a larger separation distance from the tilting guide part.

Furthermore, at least a portion of at least one of the first seating groove 1131S1a, the second seating groove 1131S2a, the third-first seating groove 1131S1b, and the third-second seating groove 1131S2b may overlap the tilting guide part in the first direction (X-axis direction) or the second direction (Y-axis direction) in correspondence to the first magnet 1151a, the second magnet 1151b, the third-first magnet 1151ca, and the third-second magnet 1151cb, which will be described below. For example, the first protruding portion of the tilting guide part may overlap the first seating groove 1131S1a and the second seating groove 1131S2a in the second direction (Y-axis direction). In addition, a portion of a base of the tilting guide part may overlap the first seating groove 1131S1a and the second seating groove 1131S2a in the second direction (Y-axis direction).

The fourth holder outer surface 1131S4 may be in contact with the first holder outer surface 1131S1 and the second holder outer surface 1131S2 and may be an outer surface extending from the first holder outer surface 1131S1 and the second holder outer surface 1131S2 in the first direction (X-axis direction). In addition, the fourth holder outer surface 1131S4 may be positioned between the first holder outer surface 1131S1 and the second holder outer surface 1131S2. In other words, the fourth holder outer surface 1131S4 may be positioned to face the fifth housing side portion.

The fourth holder outer surface 1131S4 may include a fourth seating groove 1131S4a. The tilting guide part 1141 may be positioned in the fourth seating groove 1131S4a. In addition, the fastening member 1131a and the fifth housing side portion 1126 may be positioned in the fourth seating groove 1131S4a. In addition, the fourth seating groove 1131S4a may include a plurality of areas. The fourth seating groove 1131S4a may include a first area AR1, a second area AR2, and a third area AR3.

The fastening member 1131a may be positioned in the first area AR1. In particular, the member base unit of the fastening member 1131a may be positioned in the first area AR1. In other words, the first area AR1 may overlap the fastening member 1131a in the first direction (X-axis direction). In this case, the first area AR1 may be positioned on the fourth holder outer surface 1131S4. In other words, the first area AR1 may correspond to an area positioned above the fourth seating groove 1131S4a. In this case, the first area AR1 may not be one area in the fourth seating groove 1131S4a.

The fifth housing side portion 1126 may be positioned in the second area AR2. Furthermore, a portion of the fastening member 1131a may be positioned in the second area AR2. In other words, the second area AR2 may overlap the fifth housing side portion 1126 in the first direction (X-axis direction).

In addition, the second area AR2 may be positioned on the fourth holder outer surface 1131S4 like the first area AR1. In other words, the second area AR2 may correspond to an area positioned above the fourth seating groove 1131S4a.

The tilting guide part may be positioned in the third area AR3. In particular, the base of the tilting guide part may be positioned in the third area AR3. In other words, the third area AR3 may overlap the tilting guide part (e.g., the base) in the first direction (X-axis direction).

In addition, the second area AR2 may be positioned between the first area AR1 and the third area AR3.

In addition, the fastening member may be disposed in the first area AR1, and the first groove gr1 may be positioned in the fastening member 1131a. In an embodiment, the fastening member 1131a may include the first groove gr1 formed in an inner surface thereof. In addition, the first magnetic part may be disposed in the first groove gr1 as described above. In other words, the first magnetic part may also be seated in the first area AR1.

In addition, as described above, the fifth housing side portion may be disposed in the second area AR2. The first groove gr1 may be positioned to face the second groove gr2. For example, at least a portion of the first groove gr1 may overlap the second groove gr2 in the third direction (Z-axis direction).

In addition, the repulsive force generated by the second magnetic part may be transmitted to the fourth seating groove 1131S4a of the holder 1131 through the fastening member. Therefore, the holder may apply a force to the tilting guide part in the same direction as the repulsive force generated by the second magnetic part.

The fifth housing side portion may include the second groove gr2 facing the first groove gr1 formed in the outer surface thereof. In addition, the fifth housing side portion may include the second protrusion groove formed in the inner surface thereof as described above. In addition, the second protruding portion may be seated in the second protrusion groove.

In addition, like the second magnetic part, the repulsive force generated by the first magnetic part and the second magnetic part may be applied to the fifth housing side portion. Therefore, the fifth housing side portion and the fastening member may press the tilting guide part disposed between the fifth housing side portion and the holder 1131 through the repulsive force. The tilting guide part 1141 may be disposed in the third area AR3.

In addition, the first protrusion groove PH1 may be positioned in the fourth seating groove 1131S4a. In addition, the first protruding portion of the tilting guide part 1141 may be accommodated in the first protrusion groove PH1. Therefore, the first protruding portion PR1 may be in contact with the first protrusion groove. A maximum diameter of the first protrusion groove PH1 may correspond to a maximum diameter of the first protruding portion PR1. This may also be applied to the second protrusion groove and the second protruding portion PR2 in the same manner. In other words, a maximum diameter of the second protrusion groove may correspond to a maximum diameter of the second protruding portion PR2. Therefore, the second protruding portion may be in contact with the second protrusion groove. With this configuration, a first-axis tilting may be easily performed based on the first protruding portion, a second-axis tilting may be easily performed based on the second protruding portion, and a tilting radius can be increased.

In addition, in an embodiment, a plurality of first protrusion grooves PH1 may be formed. For example, any one of the first protrusion groove PH1 and the second protrusion groove PH2 may include a first-first protrusion groove PHla and a first-second protrusion groove PHIb. The following description will be made based on the first protrusion groove PH1 including the first-first protrusion groove PHla and the first-second protrusion groove Ph1b. In addition, the following description may also be applied to the second protrusion groove PH2 in the same manner. For example, the second protrusion groove PH2 may include a second-first protrusion groove and a second-second protrusion groove, the description of the first-first protrusion groove may be applied to the second-first protrusion groove, and the description of the first-second protrusion groove may be applied to the second-second protrusion groove.

The first-first protrusion groove PH1a and the first-second protrusion groove PH1b may be disposed side by side in the first direction (X-axis direction). The first-first protrusion groove PH1a and the first-second protrusion groove PH1b may have the same maximum area.

The plurality of first protrusion grooves PH1 may have inclined surfaces of which the number differs from each other. For example, the first protrusion groove PH1 may include a groove lower surface and an inclined surface. In this case, the plurality of protrusion grooves may have inclined surfaces of which the number differs from each other. In addition, an area of each lower surface of the protrusion groove may also be different.

For example, the first-first protrusion groove PH1a may include a first groove lower surface LS1 and a first inclined surface CS1. The first-second protrusion groove PH1b may include a second groove lower surface LS2 and a second inclined surface CS2.

In this case, the first groove lower surface LS1 and the second groove lower surface LS2 may have different areas. The first groove lower surface LS1 may have a smaller area than the second groove lower surface LS2 has.

In addition, the number of first inclined surfaces CS1 in contact with the first groove lower surface LS1 may differ from the number of second inclined surfaces CS2 in contact with the second groove lower surface LS2. For example, the number of first inclined surfaces CS1 may be larger than the number of second inclined surfaces CS2.

With this configuration, it is possible to easily compensate an assembly tolerance of the first protruding portion seated in the first protrusion groove PH1. For example, since the number of first inclined surfaces CS1 is larger than the number of second inclined surfaces CS2, the first protruding portion may be in contact with more inclined surfaces, thereby more accurately maintaining the position of the first protruding portion in the first-first protrusion groove PH1a.

Unlike this, in the first-second protrusion groove PH1b, the number of inclined surfaces in contact with the first protruding portion may be smaller than those of the first-first protrusion groove PH1a, thereby easily adjusting the position of the first protruding portion.

In an embodiment, the second inclined surfaces CS2 may be disposed to be spaced apart from each other in the second direction (Y-axis direction). In addition, the second groove lower surface LS2 may extend in the first direction (X-axis direction) so that the first protruding portion may be easily moved in the first direction (X-axis direction) in a state of being in contact with the second inclined surface CS2. In other words, the position of the first protruding portion in the first-second protrusion groove PH1b may be easily adjusted.

In addition, in the embodiment, the first area AR1, the second area AR2, and the third area AR3 may have different heights in the first direction (X-axis direction). In an embodiment, the first area AR1 may have a larger height than the second area AR2 and the third area AR3 have in the first direction (X-axis direction). Therefore, a stepped different may be positioned between the first area AR1 and the second area AR2.

In addition, the fastening member 1131a may include the first groove gr1. In other words, the first groove gr1 may be positioned in an inner surface of a member base unit 1131aa. In addition, the above-described first magnetic part may be seated in the first groove gr1. In addition, a plurality of first grooves gr1 may be formed according to the number of first magnetic parts. In other words, the number of first grooves gr1 may correspond to the number of first magnetic parts.

Furthermore, an area of the first groove gr1 may differ from an area of the second groove gr2. For example, the area of the first groove gr1 may be larger than the area of the second groove gr2. Therefore, the center of gravity may be moved closer to the tilting guide part. Therefore, it is possible to reduce a difference in a driving force due to an attitude difference and minimize the current consumption due to rotation.

In addition, the fastening member 1131a may include the member base unit 1131aa, a first extension 1131ab, and a second extension 1131ac.

The member base unit 1131aa may be positioned at the outermost side of the first camera actuator. The member base unit 1131aa may be positioned outside the fifth housing side portion. In other words, the fifth housing side portion may be positioned between the member base unit 1131aa and the tilting guide part.

The first extension 1131ab may extend from an edge of the member base unit 1131aa in the third direction (Z-axis direction). Furthermore, the first extension 1131ab may extend in the second direction (Y-axis direction) after being bent. For example, the first extension 1131ab may extend in a direction opposite to a direction facing the first groove gr1. In other words, the first extension 1131ab may extend from the member base unit 1131aa to the holder 1131. This is also applied to the second extension 1131ac in the same manner. In addition, the second extension 1131ac may extend from the edge of the member base unit 1131aa in the third direction (Z-axis direction). In an embodiment, the first extension 1131ab and the second extension 1131ac may be positioned on the edge of the member base unit 1131aa in the second direction (Y-axis direction). In addition, the first extension 1131ab and the second extension 1131ac may be disposed between the upper member and the lower member.

Therefore, the fastening member 1131a may have a groove formed by the first extension 1131ab and the second extension 1131ac. In other words, the groove may be positioned between the first extension 1131ab and the second extension 1131ac. Therefore, the first extension 1131ab and the second extension 1131ac may be connected by only the member base unit 1131aa. With this configuration, the fastening member 1131a may continuously receive the repulsive force generated by the first magnetic part seated at the center of the member base unit 1131aa, particularly, in the first groove gr1.

In addition, since the fastening member 1131a is coupled to the holder to move during X-axis tilting and Y-axis tilting, the stiffness of the fastening member 1131a may be larger than that of the fifth housing side portion.

Furthermore, as described above, the fifth housing side portion according to the embodiment may have the upper member and the lower member to increase the stiffness. With this configuration, it is possible to reduce a difference in stiffness between the fastening member and the fifth housing side portion. Therefore, when the fastening member 1131a and the holder 1131 coupled to the fastening member 1131a are tilted about the X-axis or the Y-axis, the fastening member 1131a may have a smaller adjacent distance to the fifth housing side portion and may be in contact with the fifth housing side portion. Therefore, the fifth housing side portion may have improved stiffness as described above to easily perform an operation as a stopper. In other words, it is possible to improve the reliability of the camera actuator.

In addition, the first extension 1131ab may be spaced apart from the second extension 1131ac in the second direction (Y-axis direction) to form a separation space. The fifth housing side portion and the tilting guide part may be seated in the separation space. In addition, the second magnetic part and the first magnetic part may be positioned in the separation space.

In addition, the first extension 1131ab and the second extension 1131ac may have the same length in the third direction (Z-axis direction). Therefore, a coupling strength, a weight, and the like may be formed in a balanced manner so that the tilting of the holder may be accurately performed without bias to one side.

In addition, the first extension 1131ab and the second extension 1131ac may be coupled to the holder. In the specification, it should be understood that the coupling may be made through the bonding member other than the above-described protrusion and groove structures. In an embodiment, the first extension 1131ab and the second extension 1131ac may include a coupling groove 1131L that is open outward. Since the bonding member (e.g., an epoxy) is applied through the coupling groove 1131L, the first extension 1131ab and the second extension 1131ac may be easily coupled to the holder or the fourth holder outer surface. However, in the specification, it should be understood that the positions of the protrusion and groove structures for coupling may be interchanged.

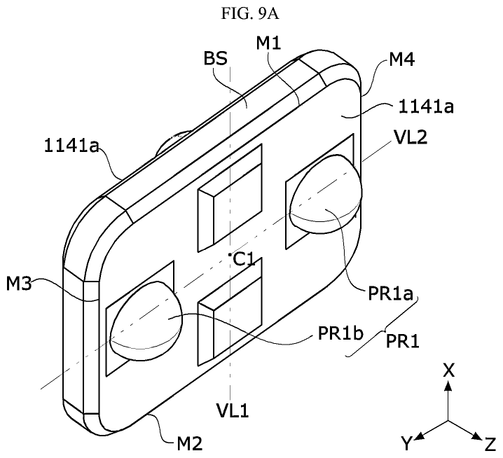

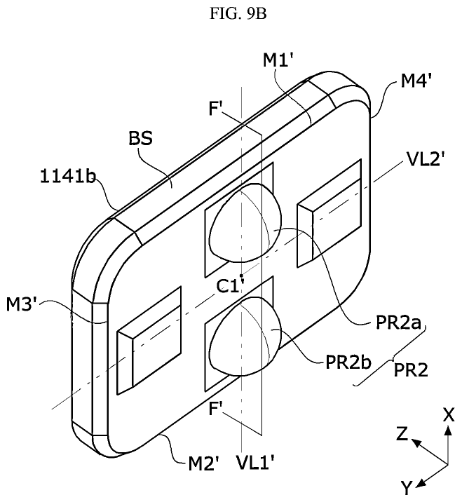

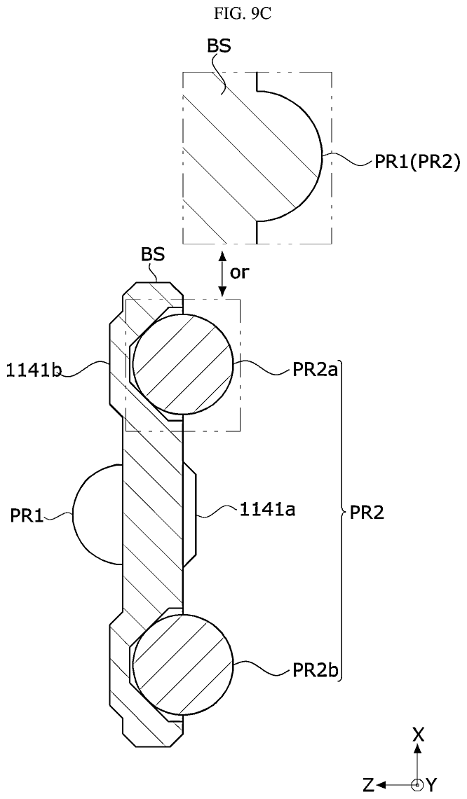

FIG. 9A is a perspective view of a tilting guide part of the first camera actuator according to the embodiment, FIG. 9B is a perspective view in a different direction from FIG. 9A, and FIG. 9C is a cross-sectional view along line F-F′ in FIG. 9B.

The tilting guide part 1141 according to the embodiment may include a base BS, the first protruding portion PR1 protruding from a first surface 1141a of the base BS, and the second protruding portion PR2 protruding from a second surface 1141b of the base BS. In addition, the first protruding portion and the second protruding portion may be formed on the second surface 1141b and the first surface 1141a, respectively, but the present invention will be described below based on the drawings. In addition, it should be understood that the first protruding portion PR1 and the second protruding portion PR2 may be integrally formed with the base BS, and as illustrated in the drawings, the first protruding portion PR1 and the second protruding portion PR2 may have a spherical shape like a ball. For example, the base BS of the tilting guide part 1141 may include grooves at positions corresponding to the first protruding potion PR1 and the second protruding portion PR2. In addition, the ball may be inserted into the groove of the base BS. In addition, the tilting guide part 1141 may have a structure in which the above-described protruding portion (first protruding portion or second protruding portion), the grooves of the base BS, and the balls inserted into the grooves are combined in various manners.

First, the base BS may include the first surface 1141a and the second surface 1141b opposite to the first surface 1141a. In other words, the first surface 1141a may be spaced apart from the second surface 1141b in the third direction (Z-axis direction), and the first surface 1141a and the second surface 1141b may be outer surfaces opposite to each other or facing each other in the tilting guide part 1141. For example, the first surface 1141a is a surface adjacent to the holder, and the second surface 1141b is a surface adjacent to the fifth housing side portion.

The tilting guide part 1141 may include the first protruding portion PR1 extending to one side on the first surface 1141a. According to the embodiment, the first protruding portion PR1 may protrude toward the holder from the first surface 1141a. The first protruding portion PR1 may be provided as a plurality off first protruding portions and may include a first-first protrusion PRla and a first-second protrusion PR1b.

The first-first protrusion PR1a and the first-second protrusion PR1b may be positioned side by side in the second direction (Y-axis direction). In other words, the first-first protrusion PRla and the first-second protrusion PRIb may overlap each other in the second direction (Y-axis direction). In addition, in an embodiment, the first-first protrusion PRla and the first-second protrusion PR1b may be bisected by virtual lines VL1 and VL2 or virtual planes extending in the first direction (X-axis direction) or the second direction (Y-axis direction).

In addition, each of the first-first protrusion PRla and the first-second protrusion PRIb may have a curved surface and have, for example, a hemispherical shape. Therefore, a center of the first protruding portion PR1 may be positioned on the first surface 1141a. Therefore, the rotation (Y-axis tilting) of the tilting guide part may be performed based on the first surface 1141a.

In addition, an align groove may be positioned in the first surface 1141a. The align groove may be disposed at one side of the first surface 1141a to guide an assembling position or assembling direction of the tilting guide part 1141 in an assembling process.

In addition, the tilting guide part 1141 may include the second protruding portion PR2 extending to one side on the second surface 1141b. According to the embodiment, the second protruding portion PR2 may protrude toward the housing from the second surface 1141b. In addition, the second protruding portion PR2 may be provided as a plurality of second protruding portions and may include a second-first protrusion PR2a and a second-second protrusion PR2b in an embodiment. Likewise, since a center of the second protruding portion PR2 is present on the second surface 1141b, the rotation (X-axis tilting) of the tilting guide part may be performed based on the second surface 1141b.

The second-first protrusion PR2a and the second-second protrusion PR2b may be positioned side by side in the first direction (X-axis direction). In other words, the second-first protrusion PR2a and the second-second protrusion PR2b may overlap each other in the first direction (X-axis direction). In addition, in an embodiment, the second-first protrusion PR2a and the second-second protrusion PR2b may be bisected by virtual lines VL1′ and VL2′ or virtual planes extending in the first direction (X-axis direction) or the second direction (Y-axis direction).

Each of the second-first protrusion PR2a and the second-second protrusion PR2b may have a curvature and have, for example, a hemispherical shape. In addition, the second-first protrusion PR2a and the second-second protrusion PR2b may be in contact with the fastening member 1131a at a point spaced apart from the second surface 1141b of the base BS.

The first-first protrusion PR1a and the first-second protrusion PR1b may be positioned in an area between the second-first protrusion PR2a and the second-second protrusion PR2b in the second direction. According to the embodiment, the first-first protrusion PR1a and the first-second protrusion PR1b may be positioned at the center of a separation space between the second-first protrusion PR2a and the second-second protrusion PR2b in the first direction. With this configuration, the actuator according to the embodiment may have an angle of the X-axis tilting in the same range with respect to the X-axis. In other words, the tilting guide part 1141 and the holder may equally provide a range (e.g., a positive/negative range) in which the Y-axis tilting may be performed based on the first-first protrusion PR1a and the first-second protrusion PR1b with respect to the Y-axis.

In addition, the second-first protrusion PR2a and the second-second protrusion PR2b may be positioned in an area between the first-first protrusion PR1a and the first-second protrusion PR1b in the second direction. According to the embodiment, the second-first protrusion PR2a and the second-second protrusion PR2b may be positioned at the center of a separation space between the first-first protrusion PR1a and the first-second protrusion PR1b in the first direction. With this configuration, the actuator according to the embodiment may have an angle of the X-axis tilting in the same range with respect to the X-axis. In other words, the tilting guide part 1141 and the holder may equally provide a range (e.g., a positive/negative range) in which the X-axis tilting may be performed based on the second-first protrusion PR2a and the second-second protrusion PR2b with respect to the X-axis.

Specifically, the first surface 1141a may include a first outer line M1, a second outer line M2, a third outer line M3, and a fourth outer line M4. The first outer line M1 and the second outer line M2 may face each other, and the third outer line M3 and the fourth outer line M4 may face each other. In addition, the third outer line M3 and the fourth outer line M4 may be positioned between the first outer line M1 and the second outer line M2. In addition, the first outer line M1 and the second outer line M2 may be perpendicular to the first direction (X-axis direction), but the third outer line M3 and the fourth outer line M4 may be parallel to the first direction (X-axis direction).

In this case, the first protruding portion PR1 may be positioned on the second virtual line VL2. Here, the first virtual line VL1 is a line that bisects the first outer line M1 and the second outer line M2. Alternatively, the first and third virtual lines VL1 and VL1′ are lines that bisect the base BS in the second direction (Y-axis direction). Therefore, the tilting guide part 1141 may easily perform the Y-axis tilting through the first protruding portion PR1. In addition, since the tilting guide part 1141 performs the Y-axis tilting with respect to the second virtual line VL2, a rotating force may be uniformly applied to the tilting guide part 1141. Therefore, it is possible to precisely perform the X-axis tilting and improve the reliability of the element.

In addition, the first-first protrusion PR1a and the first-second protrusion PR1b may be symmetrically disposed with respect to the first virtual line VL1 and the second virtual line VL2. Alternatively, the first-first protrusion PR1a and the first-second protrusion PR1b may be symmetrically positioned with respect to a first central point C1. With this configuration, upon performing the Y-axis tilting, a support force supported by the first protruding portion PR1 may be equally applied to upper and lower sides with respect to the second virtual line VL2. Therefore, it is possible to improve the reliability of the tilting guide part. Here, the second virtual line VL2 is a line that bisects the third outer line M3 and the fourth outer line M4. Alternatively, the second and fourth virtual lines VL2 and VL2′ are lines that bisect the base BS in the first direction (X-axis direction).

In addition, the first central point C1 may be an intersection of the first virtual line VL1 and the second virtual line VL2. Alternatively, the first central point C1 may be disposed at a point (e.g., overlapping) corresponding to the center of gravity in the third direction according to a shape of the tilting guide part 1141.

In addition, the second surface 1141b may include a fifth outer line M1′, a sixth outer line M2′, a seventh outer line M3′, and an eighth outer line M4′. The fifth outer line M1′ and the sixth outer line M2′ may face each other, and the seventh outer line M3′ and the eighth outer line M4′ may face each other. In addition, the seventh outer line M3′ and the eighth outer line M4′ may be positioned between the fifth outer line M1′ and the sixth outer line M2′. In addition, the fifth outer line M1′ and the sixth outer line M2′ may be perpendicular to the first direction (X-axis direction), but the seventh outer line M3′ and the eighth outer line M4′ may be parallel to the first direction (X-axis direction).

In addition, since the tilting guide part 1141 performs the X-axis tilting with respect to the third virtual line VL1′, a rotating force may be uniformly applied to the tilting guide part 1141. Therefore, it is possible to precisely perform the X-axis tilting and improve the reliability of the element.

In addition, the second-first protrusion PR2a and the second-second protrusion PR2b may be symmetrically disposed on the third virtual line VL1′ with respect to the fourth virtual line VL2′. Alternatively, the second-first protrusion PR2a and the second-second protrusion PR2b may be symmetrically positioned with respect to a second central point C1′. With this configuration, upon performing the X-axis tilting, a support force supported by the second protruding portion PR2 may be equally applied to upper and lower sides of the tilting guide part with respect to the third virtual line VL1′. Therefore, it is possible to improve the reliability of the tilting guide part. Here, the third virtual line VL1′ is a line that bisects the fifth outer line M1′ and the sixth outer line M2′. In addition, the second central point C1′ may be an intersection of the third virtual line VL1′ and the fourth virtual line VL2′. Alternatively, the second central point C1′ may be a point corresponding to the center of gravity according to the shape of the tilting guide part 1141.

In addition, a distance between the first-first protrusion PR1a and the first-second protrusion PR1b in the second direction (Y-axis direction) may be larger than a length of the second protruding portion PR2 in the second direction (Y-axis direction). Therefore, when the Y-axis tilting is performed based on the first-first protrusion PR1a and the first-second protrusion PR1b, it is possible to minimize resistance due to the second protruding portion PR2.

Correspondingly, a distance between the second-first protrusion PR2a and the second-second protrusion PR2b in the first direction (X-axis direction) may be larger than a length of the first protruding portion PR1 in the first direction (X-axis direction). Therefore, when the X-axis tilting is performed based on the second-first protrusion PR2a and the second-second protrusion PR2b, it is possible to minimize resistance due to the first protruding portion PR1.

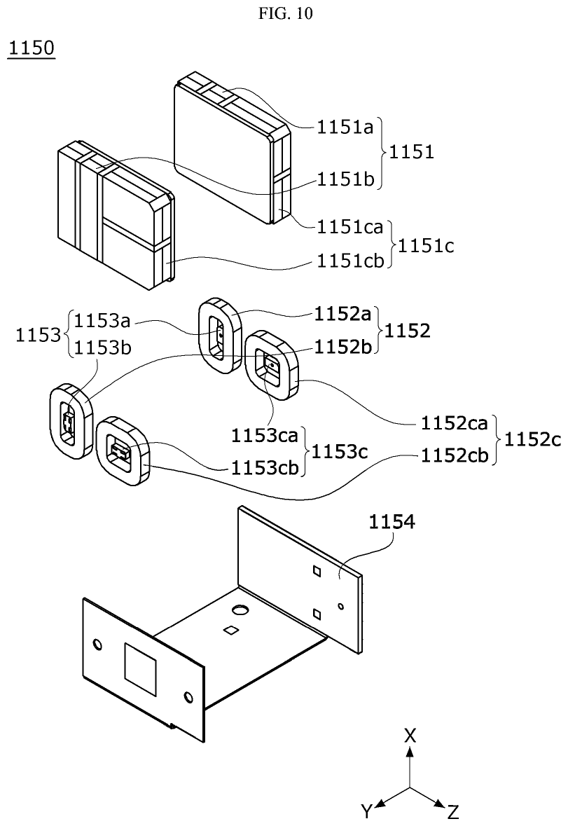

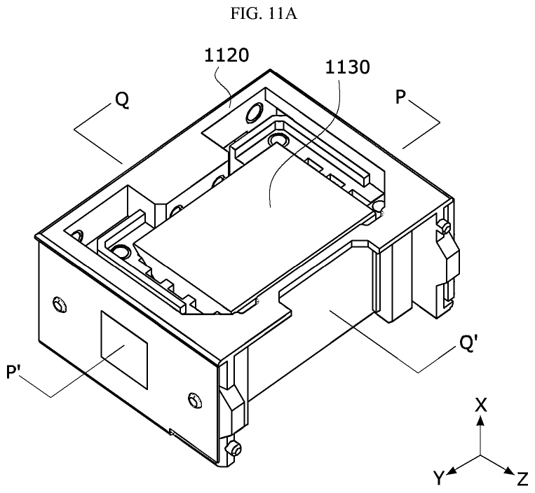

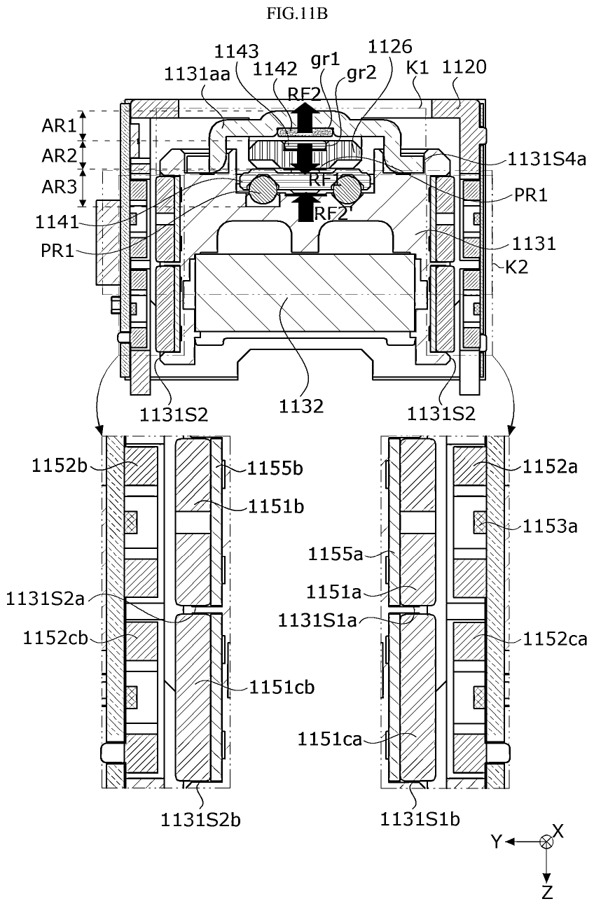

FIG. 10 is a view of a first driving unit of the first camera actuator according to the embodiment.

Referring to FIG. 10, the first driving unit 1150 includes the first driving magnet 1151, the first driving coil 1152, the Hall sensor unit 1153, the first board unit 1154, and the yoke unit (not illustrated).

In addition, as described above, the first driving magnet 1151 may include the first magnet 1151a, the second magnet 1151b, the third-first magnet 1151ca, and the third-second magnet 1151cb, which provide a driving force generated by an electromagnetic force. The first magnet 1151a, the second magnet 1151b, the third-first magnet 1151ca, and the third-second magnet 1151cb may each be positioned adjacent to the outer surface of the holder 1131. For example, the first magnet 1151a, the second magnet 1151b, the third-first magnet 1151ca, and the third-second magnet 1151cb may each be positioned in the groove of the outer surface of the holder 1131.

In addition, the first driving coil 1152 may include a plurality of coils. In an embodiment, the first driving coil 1152 may include at least one coil, and the at least one coil may be positioned to correspond to at least one of the above-described first driving magnet. For example, the first driving coil 1152 may include a first coil 1152a, a second coil 1152b, a third-first coil 1152ca, and a third-second coil 1152cb.

The first coil 1152a may be positioned to face the first magnet 1151a. Therefore, as described above, the first coil 1152a may be positioned in the first housing hole 1121a of the first housing side portion 1121. In addition, the second coil 1152b may be positioned to face the second magnet 1151b. Therefore, as described above, the second coil 1152b may be positioned in the second housing hole 1122a of the second housing side portion 1122.

The third-first coil 1152ca may be positioned to face the third-first magnet 1151ca. The third-second coil 1152cb may be positioned to face the third-second magnet 1151cb.

The first camera actuator according to the embodiment may control the mover 1130 to rotate about the first axis (in the X-axis direction) or the second axis (in the Y-axis direction) by the electromagnetic force generated between the first driving magnet 1151 and the first driving coil 1152, thereby minimizing the occurrence of a decentering or tilting phenomenon and providing the best optical characteristics upon implementing an OIS.

In addition, according to the embodiment, it is possible to provide an ultra-slim and ultra-small camera actuator and the camera module including the same by implementing an OIS through the tilting guide part 1141 of the rotating unit 1140 disposed between the first housing 1120 and the mover 1130 to resolve the size limit of the actuator.

In addition, the first coil 1152a and the third-first coil 1152ca may at least partially overlap in the third direction (Z-axis direction). The second coil 1152b and the third-second coil 1152cb may at least partially overlap in the third direction (Z-axis direction). In addition, the first coil 1152a and the third-first coil 1152ca may be disposed to be spaced apart from each other in the third direction (Z-axis direction). In addition, the second coil 1152b and the third-second coil 1152cb may be disposed to be spaced apart from each other in the third direction (Z-axis direction).

The first board unit 1154 may include a first board side portion 1154a, a second board side portion 1154b, and a third board side portion 1154c.

The first board side portion 1154a and the second board side portion 1154b may be disposed to face each other. In addition, the third board side portion 1154c may be positioned between the first board side portion 1154a and the second board side portion 1154b.

In addition, the first board side portion 1154a may be positioned between the first housing side portion and the shield can, and the second board side portion 1154b may be positioned between the second housing side portion and the shield can. In addition, the third board side portion 1154c may be positioned between the third housing side portion and the shield can and may be a lower surface of the first board unit 1154.

The first board side portion 1154a may be coupled to and electrically connected to the first coil 1152a and the third-first coil 1152ca. In addition, the first board side portion 1154a may be coupled to and electrically connected to a first Hall sensor 1153a.

The second board side portion 1154b may be coupled to and electrically connected to the second coil 1152b and the third-second coil 1152cb. In addition, it should be understood that the second board side portion 1154b may be coupled to and electrically connected to the second Hall sensor.

The third board side portion 1154c may be connected to the first board side portion 1154a and the second board side portion 1154b.

In addition, the Hall sensor unit 1153 may include the first Hall sensor 1153a, a second Hall sensor 1153b, a third-first Hall sensor 1153ca, and a third-second Hall sensor 1153cb. The first Hall sensor 1153a may be positioned in the first coil 1152a. The second Hall sensor 1153b may be positioned in the second coil 1152b. The third-first Hall sensor 1153ca may be positioned in the third-first coil 1153ca. The third-second Hall sensor 1153cb may be positioned in the third-second coil 1153cb.

The yoke unit (not illustrated) may include a first yoke, a second yoke, a third-first yoke, and a third-second yoke. The first yoke may be positioned in the first seating groove and coupled to the first magnet 1151a. In addition, the second yoke may be positioned in the second seating groove and coupled to the second magnet 1151b. In addition, the third-first yoke and the third-second yoke may be positioned in the third-first seating groove and the third-second seating groove and coupled to the third-first magnet and the third-second magnet. The first yoke to the third-second yoke allow the first magnet to the third-second magnet to be easily seated in the first to third-second seating grooves and be coupled to the housing.

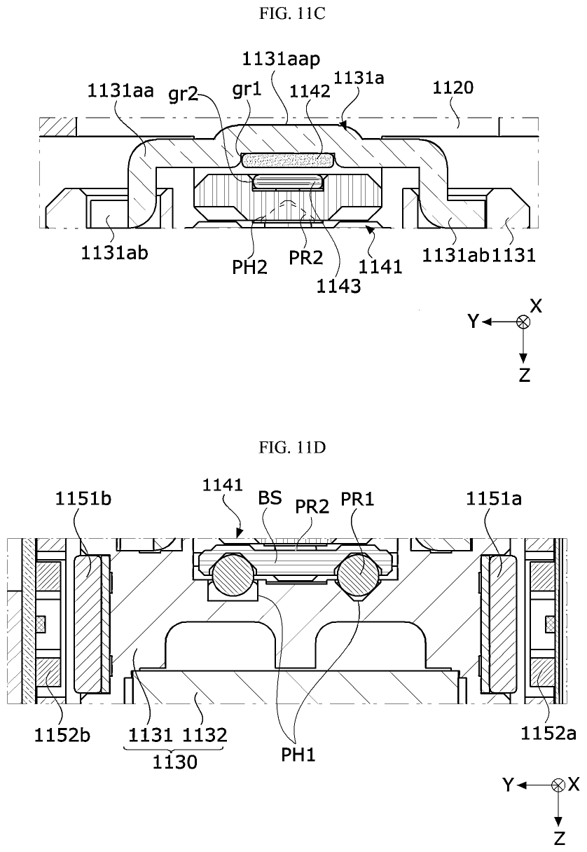

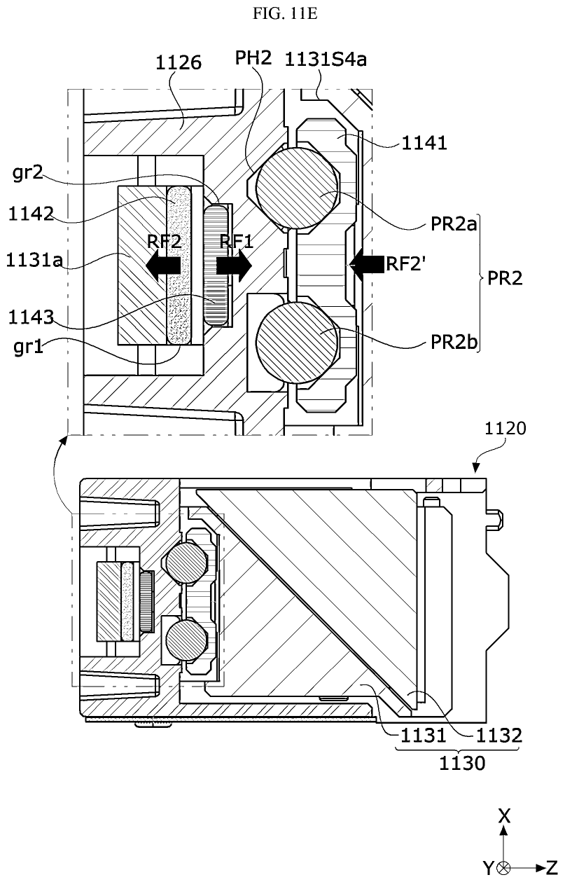

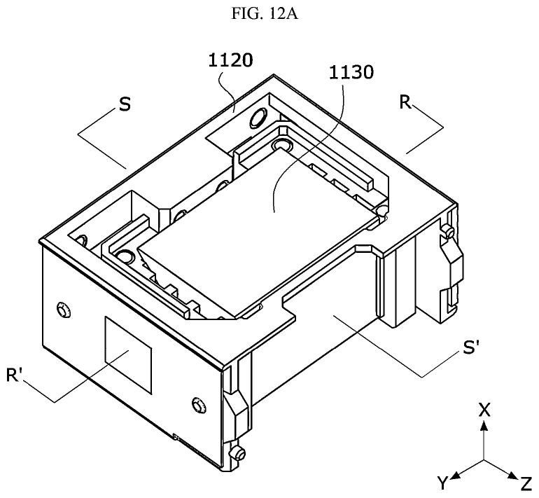

FIG. 11A is a perspective view of the first camera actuator according to the embodiment, FIG. 11B is a cross-sectional view along line P-P′ in FIG. 11A, FIG. 11C is an enlarged view of portion K1 in FIG. 11B, FIG. 11D is an enlarged view of portion K2 in FIG. 11B, and FIG. 11E is a cross-sectional view along line Q-Q′ in FIG. 11A.

Referring to FIGS. 11A to 11E, the first coil 1152a may be positioned on the first housing side portion 1121, and the first magnet 1151a may be positioned on the first holder outer surface 1131S1 of the holder 1131. Therefore, the first coil 1152a and the first magnet 1151a may be positioned to face each other. At least a portion of the first magnet 1151a may overlap the first coil 1152a in the second direction (Y-axis direction).

The third-first coil 1152ca may be positioned on the first housing side portion 1121. The third-first magnet 1151ca may be positioned on the first holder outer surface 1131S1. In particular, the third-first magnet 1151ca may be positioned in the third-first seating groove 1131S1b of the first holder outer surface 1131S1. Therefore, the third-first coil 1152ca and the third-first magnet 1151ca may be positioned to face each other. At least a portion of the third-first magnet 1151ca may overlap the third-first coil 1152ca in the second direction (Y-axis direction).

In addition, the second coil 1152b may be positioned on the second housing side portion 1122, and the second magnet 1151b may be positioned on the second holder outer surface 1131S2 of the holder 1131. Therefore, the second coil 1152b and the second magnet 1151b may be positioned to face each other. At least a portion of the second magnet 1151b may overlap the second coil 1152b in the second direction (Y-axis direction).

In addition, the third-second coil 1152cb may be positioned on the second housing side portion 1122. The third-second magnet 1151cb may be positioned on the second holder outer surface 1131S2. In particular, the third-second magnet 1151cb may be positioned in the third-second seating groove 1131S2b of the second holder outer surface 1131S2. Therefore, the third-second coil 1152cb and the third-second magnet 1151cb may be positioned to face each other. At least a portion of the third-second magnet 1151cb may overlap the third-second coil 1152cb in the second direction (Y-axis direction).

In addition, the first coil 1152a and the second coil 1152b may overlap each other in the second direction (Y-axis direction), and the first magnet 1151a and the second magnet 1151b may at least partially overlap in the second direction (Y-axis direction).

In addition, the third-first coil 1152ca and the third-second coil 1152cb may overlap each other in the second direction (Y-axis direction). The third-first magnet 1151ca and the third-second magnet 1151cb may at least partially overlap in the second direction (Y-axis direction).

With this configuration, the electromagnetic force applied to the outer surfaces of the holder (the first holder outer surface and the second holder outer surface) may be positioned on an axis parallel to the second direction (Y-axis direction) so that the X-axis tilting may be performed accurately and precisely.

In addition, the second protruding portion PR2a or PR2b of the tilting guide part 1141 may be in contact with the fifth housing side portion 1126 of the first housing 1120. The second protruding portion PR2 may be seated in the second protrusion groove PH2 formed in one side surface of the fifth housing side portion 1126. In addition, when the X-axis tilting is performed, the second protruding portion PR2a or PR2b may be a reference axis (or a rotation axes) of the tilting. Therefore, the tilting guide part 1141 and the mover 1130 may be moved in the second direction.

In addition, as described above, the first Hall sensor 1153a may be positioned outside for electrical connection and coupling with the first board unit 1154. However, the present invention is not limited to this position.

In addition, as described above, the third-first coil 1152ca and the third-second coil 1152cb may be positioned on the first housing side portion and the second housing side portion, respectively.

In addition, the third-first magnet 1151ca and the third-second magnet 1151cb may be positioned on the first holder outer surface 1131S1 and the second holder outer surface 1131S2 of the holder 1131. The third-first magnet 1151ca, the third-second magnet 1151cb, the third-first coil 1152ca, and the third-second coil 1152cb may at least partially overlap in the second direction (Y-axis direction). Therefore, intensities of electromagnetic forces between the third-first magnet 1151ca/the third-second magnet 1151cb and the third-first coil 1152ca/the third-second coil 1152cb may be easily controlled.

As described above, the tilting guide part 1141 may be positioned on the fourth holder outer surface 1131S4 of the holder 1131. In addition, the tilting guide part 1141 may be seated in the fourth seating groove 1131S4a of the fourth holder outer surface. As described above, the fourth seating groove 1131S4a may include the above-described first area, second area, and third area.

The fastening member 1131a may be disposed in the first area, and the fastening member 1131a may include the first groove gr1 formed in the inner surface thereof. In addition, as described above, the first magnetic part 1142 may be disposed in the first groove gr1, and a repulsive force RF2 generated by the first magnetic part 1142 may be transmitted to the fourth seating groove 1131S4a of the holder 1131 through the fastening member 1131a (RF2′). Therefore, the holder 1131 may apply a force to the tilting guide part 1141 in the same direction as the repulsive force RF2 generated by the first magnetic part 1142.

The fifth housing side portion 1126 may be positioned in the second area. The fifth housing side portion 1126 may include the second groove gr2 facing the first groove gr1. In addition, the fifth housing side portion 1126 may include the second protrusion groove PH2 disposed in a surface facing the second groove gr2. In addition, a repulsive force RF1 generated by the second magnetic part 1143 may be applied to the fifth housing side portion 1126. Therefore, the fifth housing side portion 1126 and the fastening member 1131a may press the tilting guide part 1141 disposed between the fifth housing side portion 1126 and the holder 1131 through the generated repulsive forces RF1 and RF2′. Therefore, even after the holder is tilted about the X-axis or the Y-axis by the current applied to the first and second coils, the third-first coil 1152ca, or the third-second coil 1152cb, the coupling between the holder 1131, the first housing 1120, and the tilting guide part 1141 may be maintained.

The tilting guide part 1141 may be disposed in the third area. As described above, the tilting guide part 1141 may include the first protruding portion PR1 and the second protruding portion PR2. In this case, the first protruding portion PR1 and the second protruding portion PR2 may be respectively disposed on the second surface and the first surface of the base. As described above, even in another embodiment to be described below, the first protruding portion PR1 and the second protruding portion PR2 may be variously positioned on the facing surfaces of the base.

The first protrusion groove PH1 may be positioned in the fourth seating groove 1131S4a. In addition, the first protruding portion PR1 of the tilting guide part 1141 may be accommodated in the first protrusion groove PH1. Therefore, the first protruding portion PR1 may be in contact with the first protrusion groove PH1. The maximum diameter of the first protrusion groove PH1 may correspond to the maximum diameter of the first protruding portion PR1. This may also be applied to the second protrusion groove PH2 and the second protruding portion PR2 in the same manner. In other words, the maximum diameter of the second protrusion groove PH2 may correspond to the maximum diameter of the second protruding portion PR2. In addition, the second protruding portion PR2 may be in contact with the second protrusion groove PH2. With this configuration, the first-axis tilting may be easily performed based on the first protruding portion PR1, the second-axis tilting may be easily performed based on the second protruding portion PR2, and the tilting radius can be increased.

In addition, since the tilting guide part 1141 may be disposed side by side with the fastening member 1131a and the fifth housing side portion 1126 in the third direction (Z-axis direction), a portion of the tilting guide part 1141 may overlap the optical member 1132 in the first direction (X-axis direction). More specifically, in an embodiment, the first protruding portion PR1 may overlap the optical member 1132 in the first direction (X-axis direction). In other words, in the camera actuator according to the embodiment, each protruding portion, which is the reference axis of the tilting, may be positioned adjacent to the center of gravity of the mover 1130. Therefore, the tilting guide part may be positioned adjacent to the center of gravity of the holder. Therefore, the camera actuator according to the embodiment can minimize a moment value at which the holder is tilted and also minimize the consumption of the current applied to the coil unit or the like to tilt the holder, thereby minimizing power consumption and improving the reliability of the element.

In other words, in an embodiment, the first magnetic part 1142 and the second magnetic part 1143 may be disposed to be spaced apart from the third-first coil 1152ca, the third-second coil 1152cb, or the optical member 1132 in the third direction (Z-axis direction). Furthermore, the first magnetic part 1142 and the second magnet part 1143 may be disposed to be spaced apart from each other in a direction opposite to the third direction from the tilting guide part 1141. In addition, the third-first coil 1152ca and the third-second coil 1152cb may be disposed to be further spaced apart from the tilting guide part 1141 in the third direction (Z-axis direction) than the first coil 1152a and the second coil 1152b. Therefore, the camera actuator according to the embodiment may easily perform vertical driving (Y-axis tilting) and can minimize power consumption.

The first camera actuator according to the embodiment may include the fastening member 1131a, the first magnetic part 1142, the second magnetic part 1143, the fifth housing side portion 1126, the tilting guide part 1141, and the holder 1131, which are sequentially disposed in the third direction. However, since the first magnetic part is positioned in the fastening member and the second magnetic part is positioned in the fifth housing side portion, the fastening member, the fifth housing side portion, the tilting guide part, and the holder may be sequentially disposed.

In addition, in an embodiment, separation distances of the first magnetic part 1142 and the second magnetic part 1143 from the holder 1131 (or the optical member 1132) in the third direction may be larger than a separation distance from the tilting guide part 1141. Therefore, the first Hall sensor 1153a to the third-second Hall sensor 1153cb disposed in the holder 1131 may also be disposed to be spaced a predetermined distance from the first magnetic part 1142 and the second magnetic part 1143. Therefore, it is possible to minimize the influence of the magnetic field generated from the first magnetic part 1142 and the second magnetic part 1143 on the first Hall sensor to the third-second Hall sensor, thereby inhibiting a Hall voltage from being saturated by being concentrated to a positive or negative value. In other words, this configuration may allow a Hall electrode to have a range in which Hall calibration may be performed. Furthermore, a temperature also affects the electrode of the Hall sensor, and resolution power of a camera lens varies depending on the temperature, but in the embodiment, it is possible to inhibit the case in which the Hall voltage is concentrated to the positive or negative value to compensate the resolution power of the lens correspondingly, thereby easily inhibiting a degradation in the resolution power.

In addition, a circuit for compensating the offset with respect to the output (i.e., the Hall voltage) of the second Hall sensor 1153b may also be easily designed.

The tilting guide part 1141 excluding the first protruding portion PR1 and the second protruding portion PR2 may be seated in the fourth seating groove 1131S4a based on the base. In other words, a length of the base BS in the third direction (Z-axis direction) may be smaller than a length of the fourth seating groove 1131S4a in the third direction (Z-axis direction). With this configuration, it is possible to realize miniaturization.

In addition, a maximum length of the tilting guide part 1141 in the third direction (Z-axis direction) may be larger than the length of the fourth seating groove 1131S4a in the third direction (Z-axis direction). Therefore, as described above, an end of the second protruding portion PR2 may be positioned between the fourth holder outer surface and the fifth housing side portion 1126. In other words, at least a portion of the second protruding portion PR2 may be further positioned in a direction opposite to the third direction (Z-axis direction) than the holder 1131. In other words, the holder 1131 may be spaced a predetermined distance from the end (portion in contact with the second protrusion groove) of the second protruding portion PR2 in the third direction (Z-axis direction).

The fifth housing side portion 1126 may have an inward extending and bent structure. In addition, some areas of the fastening member 1131a may be positioned in a groove formed by the above-described extending and bent structure of the fifth housing side portion 1126. With this configuration, since the fastening member 1131a is positioned inside the fifth housing side portion 1126, it is possible to increase space efficiency and realize miniaturization. Furthermore, even when the driving (tilting or rotation of the mover 1130) by the electromagnetic force is performed, the fastening member 1131a does not protrude outward from the fifth housing side portion 1126, and thus the contact with nearby devices can be blocked. Therefore, it is possible to improve the reliability.

In addition, a predetermined separation space may be present between the first magnetic part 1142 and the second magnetic part 1143. In other words, the first magnetic part 1142 and the second magnetic part 1143 may face each other with the same polarity.

In addition, as described above, the first driving unit may rotatably drive the mover 1130 in the first housing with respect to the first direction (X-axis direction) or the second direction (Y-axis direction). In this case, the driving magnet of the first driving unit may include at least one magnet, and the driving coil may also include at least one coil. In this case, at least a portion of the at least one magnet may overlap the tilting guide part 1141 in the first direction (X-axis direction) or the second direction (Y-axis direction). Furthermore, at least a portion of the at least one coil may also overlap the tilting guide part 1141 in the first direction (X-axis direction) or the second direction (Y-axis direction).

The first magnet 1151a and the second magnet 1151b may overlap each other in the second direction (Y-axis direction), and the tilting guide part 1141 may be positioned in an area between the first magnet 1151a and the second magnet 1151b in the second direction (Y-axis direction).

A portion of the tilting guide part 1141 may be positioned between the first magnet 1151a and the second magnet 1151b and may overlap the first magnet 1151a and the second magnet 1151b in the second direction (Y-axis direction).

For example, the first protruding portion PR1 of the tilting guide part 1141 may overlap the first magnet 1151a and the second magnet 1151b in the second direction (Y-axis direction). In this case, the first protruding portion PR1 may be positioned between the mover 1130 and the base BS of the tilting guide part 1141.

Therefore, it is possible to decrease the separation distances of the first magnet 1151a and the second magnet 1151b from the tilting guide part 1141 in the third direction (Z-axis direction). In other words, the first magnet 1151a and the second magnet 1151b may be positioned at a distance adjacent to the tilting guide part 1141. Therefore, the center of gravity of the holder 1131 on which the first magnet 1151a and the second magnet 1151b are seated or the mover 1130 including the holder 1131 may be positioned adjacent to the tilting guide part 1141. In other words, since the center of gravity of the holder 1131 or the mover 1130 including the holder 1131 is adjacent to the tilting guide part 1141 having a rotational shaft or a rotational surface for rotation driving, it is possible to decrease a change in a moment or energy (e.g., a current) consumed to perform tilting driving at a certain angle according to an attitude of the camera actuator or the camera module. In other words, it is possible to reduce the influence of an attitude difference. Therefore, the camera actuator and the camera module according to the embodiment may perform the tilting driving more accurately. In addition, since the movement of the above-described center of gravity is adjacent to the rotational shaft or the rotational surface, it is possible to decrease the electromagnetic force, which is a force of rotating the mover (or the holder). In other words, it is possible to increase the energy efficiency for driving the camera actuator or the camera module. In other words, the first driving unit may be positioned adjacent to the tilting guide part 1141. In this case, the first driving unit is the first driving magnet and the first driving coil, and hereinafter, each of the first driving magnet and the first diving coil will be described.

Furthermore, a portion of the base BS of the tilting guide part 1141 may overlap the first magnet 1151a and the second magnet 1151b in the second direction (Y-axis direction). Therefore, the first magnet 1151a and the second magnet 1151b may be disposed closer to the tilting guide part 1141. However, when the first magnet 1151a and the second magnet 1151b are positioned in front of the rotational shaft or the rotational surface, the electromagnetic force required for tilting in the second direction (Y-axis direction) increases, and thus centers (bisection point in the third direction) of the first magnet 1151a and the second magnet 1151b do not overlap the first protruding portion PR1 in the second direction (Y-axis direction) and may be disposed to be spaced apart from the first protruding portion PR1 in the third direction (Z-axis direction). Furthermore, the centers (bisection point in the third direction) of the first magnet 1151a and the second magnet 1151b may be positioned at a rear end of the first protruding portion PR1, that is, the third direction (Z-axis direction) side. In addition, centers of the third-first magnet 1151ca and the third-second magnet 1151cb may be positioned at the rear end of the first protruding portion PR1, that is, the third direction (Z-axis direction) side.

Correspondingly, at least a portion of the base BS of the tilting guide part 1141 may overlap the first coil 1152a and the second coil 1152b in the second direction (Y-axis direction). Therefore, like the above-described first magnet and second magnet, the first coil 1152a and the second coil 1152b may be disposed closer to the tilting guide part 1141. Therefore, it is possible to decrease the electromagnetic force required for tilting and reduce the influence of the attitude difference.

In addition, the third-first magnet and the third-second magnet disposed on the third holder outer surface may be disposed to be spaced apart from the first protruding portion PR1 in the first direction (X-axis direction) and the third direction (Z-axis direction). Therefore, the center of gravity of the holder 1131 or the mover 1130 including the holder 1131 may be moved further toward the tilting guide part 1141. Therefore, it is possible to reduce the influence of the attitude difference as described above.

The camera actuator and the camera module according to the embodiment may perform the tilting driving accurately. In addition, since the movement of the above-described center of gravity is adjacent to the rotational shaft or the rotational surface, it is possible to decrease the electromagnetic force, which is a force of rotating the mover (or the holder). In other words, it is possible to increase the energy efficiency for driving the camera actuator or the camera module. A description of the third-first magnet/the third-second magnet may also be applied to the third-first coil and the third-second coil in the same manner.

According to the embodiment, the center of gravity of the holder 1131 or the mover 1130 including the holder 1131 may be positioned to overlap the first protruding portion PR1 in the third direction (Z-axis direction). Therefore, it is possible to suppress an increase in a change in electromagnetic force depending on the rotational direction or the attitude difference. Therefore, the camera actuator and the camera module according to the embodiment may perform the tilting driving more accurately.

Furthermore, as described above, the mover 1130 may include the fastening member 1131a passing through one side portion of the housing (e.g., the fifth housing side portion) and may be coupled to the housing by the fastening member 1131a. Furthermore, the fastening member 1131a may have the first groove gr1, and the first magnetic part 1142 may be positioned in the first groove gr1.

In addition, the second groove gr2 may be positioned in the one side portion of the housing, for example, the outer surface of the fifth housing side portion. The second groove gr2 may be positioned to face the first groove gr1 of the fastening member 1131a. In addition, the second magnetic part 1143 may be positioned in the second groove gr2. Therefore, since the mover 1130 and the fastening member 1131a coupled to the mover 1130 to integrally perform the rotation of the first-axis tilting and second-axis tilting are coupled to the first magnetic part 1142, and the first magnetic part 1142 and the second magnetic part 1143 are positioned at a front end of the tilting guide part 1141, the centers of gravity of the mover 1130 and the fastening member 1131a may be positioned closer to the tilting guide part 1141 as described above. Therefore, it is possible to reduce the change in moment due to the attitude difference and minimize the electromagnetic force required for tilting. In this case, the second magnetic part 1143 may be positioned between the first magnetic part 1142 and the mover 1130 in the third direction.

In addition, the fastening member 1131a may be a non-magnetic part and made of metal. Furthermore, since the fastening member 1131a may have a protruding area 1131aap protruding in a direction opposite to the third direction (Z-axis direction), the above-described center of gravity may be positioned closer to the tilting guide part 1141. Furthermore, the first magnetic part 1142 and the second magnetic part 1143 may be disposed to at least partially overlap the first protruding portion PR1 in the third direction (Z-axis direction), thereby minimizing the influence of the attitude difference.

In addition, the first magnetic part 1142 and the second magnetic part 1143 may have different lengths in the first direction (X-axis direction) or the second direction (Y-axis direction), thereby further reducing the change in electromagnetic force due to the attitude difference.

In addition, the mover 1130 according to the embodiment may include the holder 1131 and the optical member 1132. In addition, as described above, the first driving magnet and the first driving coil may be disposed on a portion of the outer surface of the holder 1131. In this case, the holder 1131 may include a first side wall and a second side wall. Here, the first side wall may be the first holder outer surface and the second holder outer surface on which the magnet or the coil is positioned adjacent thereto. In addition, the second side wall may be the fourth holder outer surface on which the tilting guide part 1141 is positioned.

Based on this, the first side wall may be disposed perpendicular to the second side wall. Furthermore, the second side wall may include a cavity in which the tilting guide part 1141 is disposed. In this case, the cavity may correspond to the third area AR3 and may be an area formed by the fourth seating groove as a space in which the tilting guide part 1141 is disposed. In addition, at least a portion of the cavity according to the embodiment may overlap at least a portion of the first driving magnet or the first driving coil in a direction perpendicular to the optical axis. For example, the cavity may overlap at least portions of the first magnet and the second magnet of the first driving magnet in the second direction.

In addition, the cavity may overlap at least portions of the first coil and the second coil of the first driving coil in the second direction. In addition, the cavity may overlap the third-first and third-second magnets of the first driving magnet in the first direction. In addition, the cavity may overlap the third-first and third-second coils of the first driving coil in the first direction.

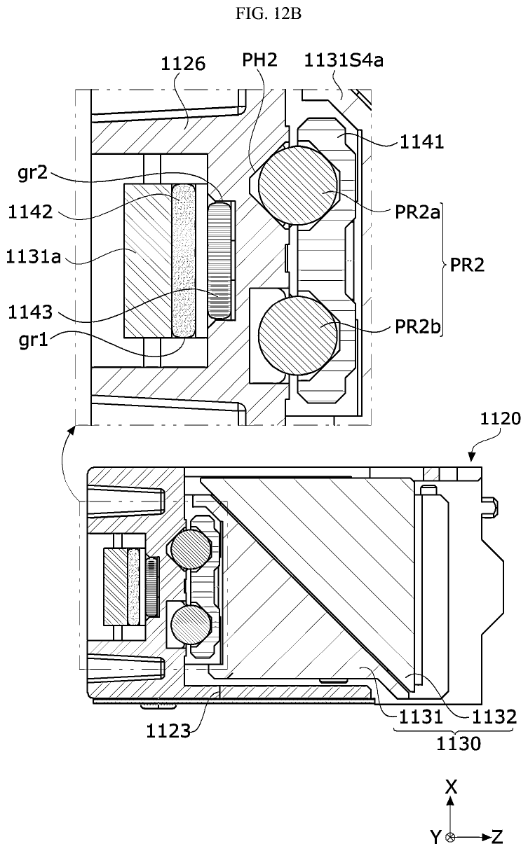

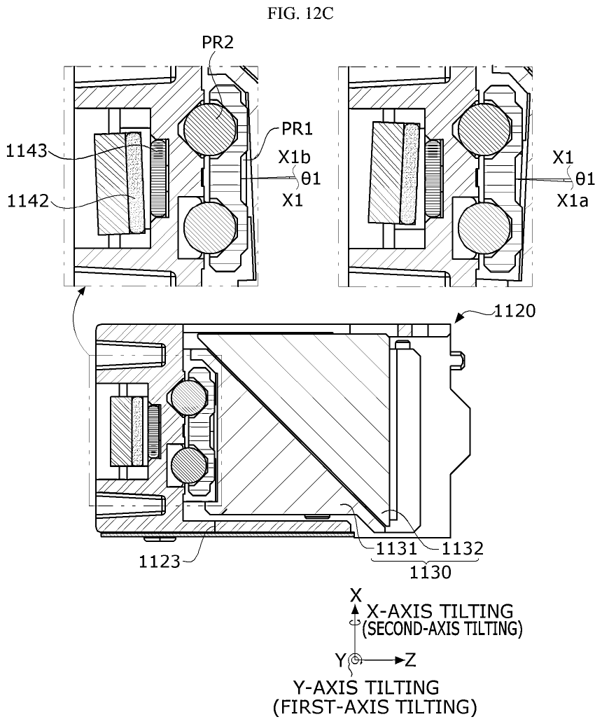

FIG. 12A is a perspective view of the first camera actuator according to the embodiment, FIG. 12B is a cross-sectional view along line S-S′ in FIG. 12A, and FIG. 12C is an exemplary view of the movement of the first camera actuator illustrated in FIG. 12B.

Referring to FIGS. 12A to 12C, the Y-axis tilting may be performed by the first camera actuator according to the embodiment. In other words, an OIS can be implemented by rotating the first camera actuator in the first direction (X-axis direction).

Specifically, the repulsive force generated between the first magnetic part 1142 and the second magnetic part 1143 may be transmitted to the fastening member 1131a and the fifth housing side portion 1126 and finally transmitted to the tilting guide part 1141 disposed between the fifth housing side portion 1126 and the holder 1131. Therefore, as described above, the tilting guide part 1141 may be pressed by the mover 1130 and the first housing 1120 by the above-described repulsive force.

In addition, the first-first protrusion PR1a and the first-second protrusion PR1b may be spaced apart from each other in the second direction (Y-axis direction) and supported by the first protrusion groove PH1 formed in the fourth seating groove 1131S4a of the holder 1131. In addition, in an embodiment, the tilting guide part 1141 may be rotated or tilted about the first protruding portion PR1 protruding toward the holder 1131 (e.g., in the third direction), which is the reference axis (or the rotation axis), that is, the second direction (Y-axis direction).

For example, an OIS can be implemented by rotating the mover 1130 in the X-axis direction or a direction opposite to the X-axis direction at a first angle by first electromagnetic forces between the third-first magnet 1151ca and third-second magnet 1151cb disposed in the third-first seating groove and the third-second seating groove and the third-first coil 1152ca and the third-second coil 1152cb disposed on the first and second board side portions. The first angle may be in a range of +1° to +3°. However, the present invention is not limited thereto.

Hereinafter, in the first camera actuators according to various embodiments, the electromagnetic force may move the mover by generating a force in the described direction or move the mover in the described direction even when a force is generated in a different direction from the illustrated direction. In other words, the directions illustrated in the drawings are directions of the force generated by the magnet and the coil to move the mover.

In addition, the first magnetic part 1142 and the second magnetic part 1143 may have different lengths in the first direction (X-axis direction).

In an embodiment, an area of the first magnetic part 1142 coupled to the fastening member 1131a and tilted together with the mover 1130 may differ from an area of the second magnetic part 1143. For example, the area of the first magnetic part 1142 may be larger than the area of the second magnetic part 1143. For example, a length of the first magnetic part 1142 in the first direction (X-axis direction) may be larger than a length of the second magnetic part 1143 in the first direction (X-axis direction). In addition, a length of the first magnetic part 1142 in the second direction (Y-axis direction) may be larger than a length of the second magnetic part 1143 in the second direction (Y-axis direction). In addition, the second magnetic part 1143 may be positioned in a virtual straight line extending both ends of the first magnetic part 1142 in the third direction.

With this configuration, even when the magnetic part at one side (e.g., the second magnetic part) is tilted upon tilting or rotating, it is possible to easily inhibit forces other than the vertical force from being generated by the tilting. In other words, even when the second magnetic part is vertically tilted together with the mover 1130, the mover may not receive a force (e.g., a repulsive force or an attractive force) against the tilting from the second magnetic part 1143. Therefore, it is possible to increase driving efficiency.

In addition, in the specification, the camera actuator may include a first-axis driving magnet and a second-axis driving magnet. The first-axis driving magnet may include the first magnet and the second magnet. In addition, the second-axis driving magnet may include the third-first magnet and the third-second magnet. Furthermore, the first-axis driving magnet may be referred to as “first sub-driving magnet,” “first-axis magnet,” “first driving magnet unit,” or the like. In addition, the second-axis driving magnet may be referred to as “second sub-driving magnet,” “second-axis magnet,” “second driving magnet unit,” or the like.

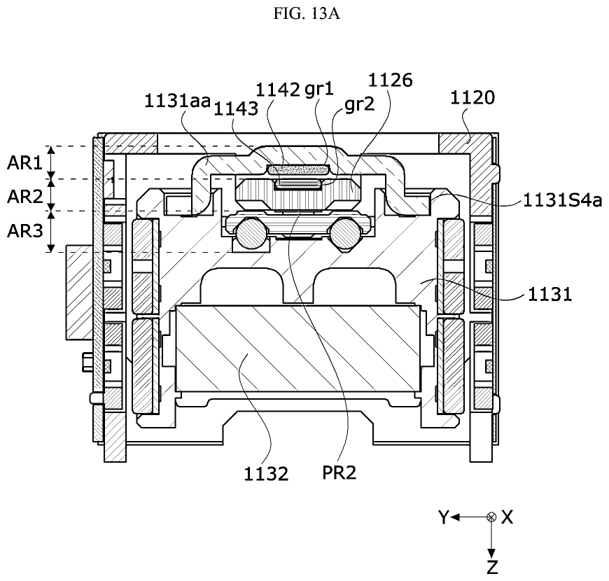

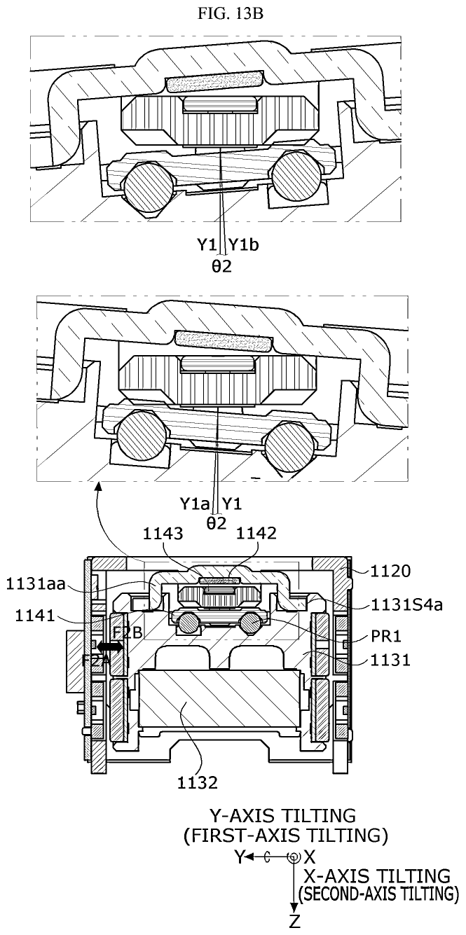

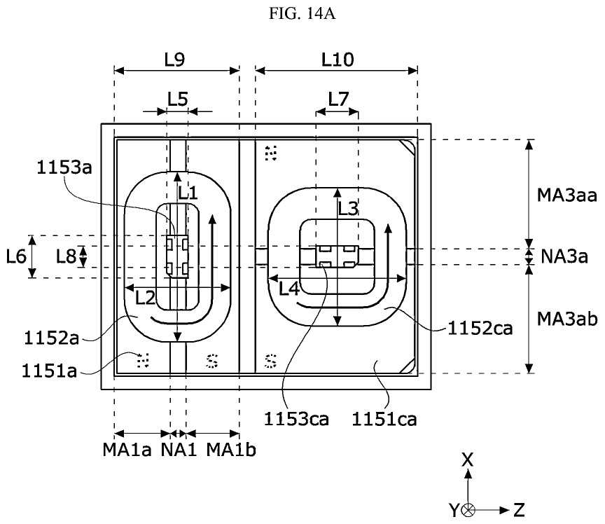

FIG. 13A is a cross-sectional view along line R-R′ in FIG. 12A, and FIG. 13B is an exemplary view of the movement of the first camera actuator illustrated in FIG. 13A.

Referring to FIGS. 13A and 13B, an X-axis tilting may be performed. In other words, an OIS can be implemented by tilting or rotating the mover 1130 in the Y-axis direction.

In an embodiment, the first magnet 1151a and the second magnet 1151b disposed in the holder 1131 may generate the electromagnetic force with the first coil 1152a and the second coil 1152b, respectively and tilt or rotate the tilting guide part 1141, the mover 1130, and the fastening member 1131a with respect to the first direction (X-axis direction).

Specifically, the repulsive force generated between the first magnetic part 1142 and the second magnetic part 1143 may be transmitted to the fifth housing side portion 1126 and the holder 1131 and finally transmitted to the tilting guide part 1141 disposed between the holder 1131 and the fifth housing side portion 1126. Therefore, the tilting guide part 1141 may be pressed by the mover 1130 and the first housing 1120 by the above-described repulsive force.

In addition, the second protruding portion PR2 may be supported by the fifth housing side portion 1126. In this case, in an embodiment, the tilting guide part 1141 may be rotated or tilted about the second protruding portion PR2 protruding toward the holder 1131, which is the reference axis (or the rotation axis), that is, the first direction (X-axis direction). In other words, the tilting guide part 1141 may be rotated or tilted about the second protruding portion PR2 protruding toward the fifth housing side portion 1126, which is the reference axis (or the rotation axis), that is, the second direction (Y-axis direction).

For example, an OIS can be implemented by rotating (Y1→Y1a or Y1b) the mover 130 at a second angle θ2 in the Y-axis direction or a direction opposite to the Y-axis direction by second electromagnetic forces F2A and F2B between the first and second magnets 1151a and 1151b disposed in the first seating groove and the first and second coils 1152a and 1152b disposed on the first and second board side portions. The second angle θ2 may be in the range of ±1° to 3°. However, the present invention is not limited thereto.

In addition, as described above, the electromagnetic forces generated by the first and second magnets 1151a and 1151b and the first and second coils 1152a and 1152b may act in the third direction or in a direction opposite to the third direction. For example, the electromagnetic force may be generated on a left side portion of the mover 1130 in the third direction (Z-axis direction) and may act on a right side portion of the mover 1130 in a direction opposite to the third direction (Z-axis direction). Therefore, the mover 1130 may be rotated with respect to the first direction. Alternatively, the mover 130 may be moved in the second direction. As described above, the illustrated direction corresponds to the moving direction of the mover and may differ from or be the same as the real direction of the electromagnetic force generated by the magnet and the coil.

As described above, the first camera actuator according to the embodiment may control the mover 1130 to be rotated in the first direction (X-axis direction) or the second direction (Y-axis direction) by the electromagnetic force generated between the first driving magnet in the holder and the first driving coil disposed in the first housing, thereby minimizing the occurrence of a decentering or tilting phenomenon and providing the best optical characteristics upon implementing an OIS. In addition, as described above, “Y-axis tilting” is rotation or tilting in the first direction (X-axis direction), and “X-axis tilting” is rotation or tilting in the second direction (Y-axis direction).

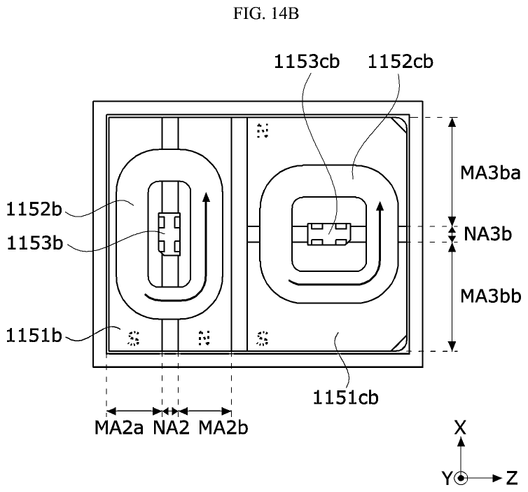

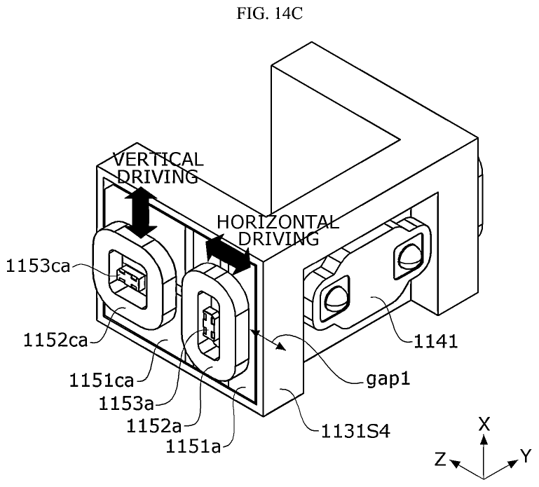

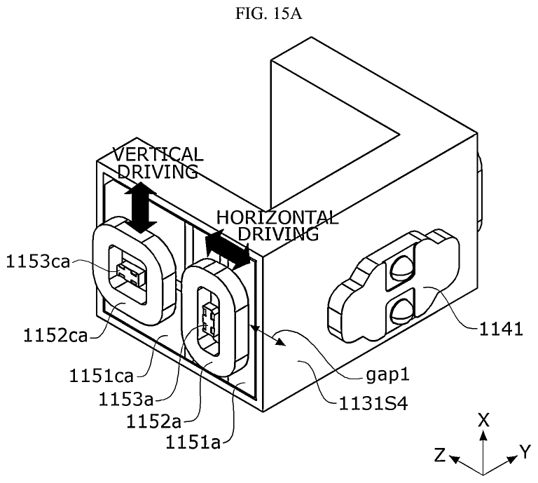

FIG. 14A is a view of one sides of a holder and a driving unit according to the embodiment, FIG. 14B is a view of the other sides of the holder and the driving unit according to the embodiment, and FIG. 14C is a view of another example of the holder, a tilting guide unit, and the driving unit according to the embodiment.

Referring to FIGS. 14A and 14B, the first magnet 1151a and the third-first magnet 1151ca may be disposed on one surface of the mover 1130. In addition, the second magnet 1151b and the third-second magnet 1151cb may be disposed on the other surface of the mover 1130. For example, the one surface of the mover 1130 may be the first holder outer surface of the holder 1131. In addition, the first magnet 1151a and the third-first magnet 1151ca may be positioned in the first seating groove and the third-first seating groove, respectively. In addition, the second magnet 1151b and the third-second magnet 1151cb may be positioned in the second seating groove and the third-second seating groove, respectively.

The first magnet 1151a and the second magnet 1151b may be closer to the tilting guide part than the third-first magnet 1151ca and the third-second magnet 1151cb are. In addition, areas of the first magnet 1151a and the second magnet 1151b may differ from areas of the third-first magnet 1151ca and the third-second magnet 1151cb. For example, the areas of the first magnet 1151a and the second magnet 1151b may be smaller than the areas of the third-first magnet 1151ca and the third-second magnet 1151cb. With this configuration, in the first camera actuator, the rotation with respect to the second direction (Y-axis direction) may be easily performed.

In addition, the first magnet 1151a and the second magnet 1151b may correspond to each other. For example, the first magnet 1151a and the second magnet 1151b may be positioned to face each other with respect to the first direction (X-axis direction) as described above. Furthermore, the first magnet 1151a and the second magnet 1151b may be symmetrically disposed with respect to the first direction (X-axis direction) as described above.

Furthermore, the third-first magnet 1151ca and the third-second magnet 1151cb may correspond to each other. The third-first magnet 1151ca and the third-second magnet 1151cb may be positioned to face each other with respect to the first direction (X-axis direction). For example, the third-first magnet 1151ca and the third-second magnet 1151cb may be symmetrically disposed with respect to the first direction (X-axis direction).

Therefore, since the third-first magnet 1151ca and the third-second magnet 1151cb have larger areas than the first magnet 1151a and the second magnet 1151b have, the tilting by the third-first magnet 1151ca and the third-second magnet 1151cb further spaced apart from the tilting guide part in the third direction (Z-axis direction) may also be easily performed.

The first magnet 1151a may include a first-first magnet area MAla and a first-second magnet area MAlb having different polarities. In addition, the first magnet 1151a may include a first neutral area NA1 disposed between the first-first magnet area MA1a and the first-second magnet area MA1b. The first neutral area NA1 may be a neutral area, a neutral zone, or a non-polarity area. Furthermore, the first neutral area NA1 may be made of a non-polarity material or may be formed with a separated groove. The first-first magnet area MA1a and the first-second magnet area MA1b may be sequentially disposed in the optical axis direction (Z-axis direction).

In addition, in the specification, a polarity providing an electromagnetic force is a polarity of a surface facing an adjacent coil. For example, the polarity is a polarity of an outer surface of each magnet or a magnet area.

The first-first magnet area MA1a and the first-second magnet area MA1b may be spaced apart from each other in the third direction (Z-axis direction). The first-first magnet area MA1a and the first-second magnet area MA1b may overlap each other in the third direction (Z-axis direction). In addition, the first-first magnet area MA1a may be an N pole, and the first-second magnet area MA1b may be an S pole.

The second magnet 1151b may include a second-first magnet area MA2a and a second-second magnet area MA2b. In addition, the second magnet 1151b may include a second neutral area NA2 disposed between the second-first magnet area MA2a and the second-second magnet area MA2b. The second neutral area NA2 may be made of a non-polarity material or may be formed with a separated groove. The second-first magnet area MA2a and the second-second magnet area MA2b may be disposed vertically. For example, the second-first magnet area MA2a may be positioned above the second-second magnet area MA2b. In addition, the first-second magnet area MA1b may have a different polarity from the second-first magnet area MA2a.

The second-first magnet area MA2a and the second-second magnet area MA2b may be spaced apart from each other in the third direction (Z-axis direction). The second-first magnet area MA2a and the second-second magnet area MA2b may overlap each other in the third direction (Z-axis direction). In addition, the second-first magnet area MA2a may be an S pole, and the second-second magnet area MA2b may be an N pole.

The first-first magnet area MA1a and the second-first magnet area MA2a may overlap each other in the second direction (Y-axis direction). The first-second magnet area MA1b and the second-second magnet area MA2b may overlap each other in the second direction (Y-axis direction).

The first-first magnet area MA1a may have the same polarity as any one of the second-first magnet area MA2a and the second-second magnet area MA2b. In addition, the first-second magnet area MA1b may have the same polarity as the other of the second-first magnet area MA2a and the second-second magnet area MA2b.

For example, the first-first magnet area MA1a and the second-second magnet area MA2b may be N poles. In addition, the first-second magnet area MA1b and the second-first magnet area MA2a may be S poles. Therefore, the polarities of the magnet areas overlapping each other in the second direction (Y-axis direction) may be different. With this configuration, when a current is applied to each coil (e.g., the first coil or the second coil) in the same direction, the mover 1130 may be tilted with respect to the first direction (X-axis direction). As another example, even when the current is applied to each coil in a different direction, the mover 1130 may be tilted with respect to the first direction (X-axis direction).

In addition, the first magnet 1151a and the third-first magnet 1151ca may be an integrated magnet or separated magnets. This may be different depending on a structure of the above-described seating groove. For example, the first magnet 1151a and the third-first magnet 1151ca may be integrally formed, and a neutral area may be positioned between the first magnet and the third-first magnet. Furthermore, the first-first magnet area and the first-second magnet area in the first magnet may be formed with bipolar-magnetized magnets. For example, when an outer surface of the first-first magnet area is an N pole, an inner surface of the first-first magnet area may be an S pole. In addition, when an outer surface of the first-second magnet area is an S pole, an inner surface of the first-second magnet area may be an N pole. Likewise, when an outer surface of the second-first magnet area is an S pole, an inner surface of the second-first magnet area may be an N pole. In addition, when an outer surface of the second-second magnet area is an N pole, an inner surface of the second-second magnet area may be an S pole.

In addition, when an outer surface of the third-first magnet area is an N pole, an inner surface of the third-first magnet area may be an S pole. In addition, when an outer surface of the third-second magnet area is an S pole, an inner surface of the third-second magnet area may be an N pole.

In addition, when an outer surface of the third-third magnet area is an N pole, an inner surface of the third-third magnet area may be an S pole. In addition, when an outer surface of the third-fourth magnet area is an S pole, an inner surface of the third-fourth magnet area may be an N pole.

According to the embodiment, the holder may be driven horizontally by the first magnet 1151a. In other words, the electromagnetic force generated by the first magnet 1151a and the second magnet 1151b may be generated in the third direction (Z-axis direction) or a direction opposite to the third direction (Z-axis direction). Therefore, the holder may be rotate with respect to the first direction (X-axis direction).

For example, a magnetic force may be generated in the second direction (Y-axis direction) or in a direction opposite to the second direction (Y-axis direction) by the first magnet 1151a. In addition, a current may flow in a direction (first-first magnet area) opposite to the first direction and the first direction (first-second magnet area) by the first coil 1152a. Therefore, the first coil 1152a may receive the electromagnetic force in a direction opposite to the third direction (Z-axis direction). In addition, since the first coil 1152a is a fixed component, the holder may be moved in the third direction (Z-axis direction).

In addition, a magnetic force may be generated in the second direction (Y-axis direction) or in a direction opposite to the second direction (Y-axis direction) by the second magnet 1151b. For example, directions of the magnetic forces may be the same in the second-first magnet area and the first-first magnet area. In addition, the direction of the magnetic force in the first-second magnet area and the direction of the magnetic force in the second-second magnet area may be the same.

In addition, the current may flow in a direction (second-first magnet area) opposite to the first direction and the first direction (second-second magnet area) by the second coil 1152b. Therefore, the second coil 1152b may receive the electromagnetic force in the third direction (Z-axis direction). In addition, since the second coil 1152b is a fixed component, the holder may be moved in a direction opposite to the third direction (Z-axis direction).

Therefore, the first holder outer surface may be moved in the third direction (Z-axis direction). In addition, the second holder outer surface may be moved in a direction opposite to the third direction (Z-axis direction). In other words, the first holder outer surface may be spaced apart from the tilting guide part, and the second holder outer surface may be adjacent to the tilting guide part. The holder may be tilted with respect to the first direction.

The electromagnetic force generated by the first magnet 1151a and the second magnet 1151b may be generated in the first direction (X-axis direction) or a direction opposite to the first direction (X-axis direction). Therefore, the holder may be moved in the first direction (X-axis direction) or a direction opposite to the first direction (X-axis direction). In other words, the holder may be rotated with respect to the second direction (Y-axis direction).

For example, the magnetic force may be generated in the second direction (Y-axis direction) by the first magnet 1151a, and the current may flow in the first coil 1152a clockwise or counterclockwise. For example, when the current flows in the first direction (X-axis direction) in the first coil 1152a and the magnetic force is generated in the second direction (Y-axis direction), the electromagnetic force may be generated in the third direction (Z-axis direction) in the first coil 1152a. Therefore, a force (generated by the electromagnetic force) may be generated in a direction opposite to the third direction (Z-axis direction) in the first holder outer surface of the holder. In addition, when the current flows in the first direction (X-axis direction) in the second coil 1152b and the magnetic force is generated in a direction opposite to the second direction (Y-axis direction), the electromagnetic force may be generated in a direction opposite to the third direction (Z-axis direction) in the first coil 1152a. Therefore, a force (generated by the electromagnetic force) may be generated in the third direction (Z-axis direction) in the second holder outer surface of the holder. Therefore, the holder may be tilted with respect to the first direction. For example, the first holder outer surface may be positioned adjacent to the tilting guide part, and the second holder outer surface may be positioned far away from the tilting guide part.

In addition, the third-first magnet 1151ca may include a third-first magnet area MA3aa and a third-second magnet area MA3ab having different polarities. The third-first magnet area MA3aa and the third-second magnet area MA3ab may overlap each other in the first direction (X-axis direction). In addition, the third-first magnet area MA3aa and the third-second magnet area MA3ab may be spaced apart from each other in the first direction (X-axis direction). Furthermore, the third-first magnet 1151ca may include a third neutral area NA3a disposed between the third-first magnet area MA3aa and the third-second magnet area MA3ab. The third-first magnet area MA3aa and the third-second magnet area MA3ab may overlap the third neutral area NA3a in the first direction (X-axis direction).

In addition, the third-second magnet 1151cb may include a third-third magnet area MA3ba and a third-fourth magnet area MA3bb having different polarities. The third-third magnet area MA3ba and the third-fourth magnet area MA3bb may overlap each other in the first direction (X-axis direction). In addition, the third-third magnet area MA3ba and the third-fourth magnet area MA3bb may be spaced apart from each other in the first direction (X-axis direction). Furthermore, the third-second magnet 1151cb may include a fourth neutral area NA3b disposed between the third-third magnet area MA3ba and the third-fourth magnet area MA3bb. The third-third magnet area MA3ba and the third-fourth magnet area MA3bb may overlap the fourth neutral area NA3b in the first direction (X-axis direction).

In addition, according to the embodiment, a first polarity orientation and a second polarity orientation may be different. The first polarity orientation may be an orientation from the third-first magnet area MA3aa toward the third-second magnet area MA3ab or an orientation from the third-third magnet area MA3ba toward the third-fourth magnet area MA3bb. In addition, the second polarity orientation may be an orientation from the first-first magnet area MA1a toward the first-second magnet area MA1b or an orientation from the second-first magnet area MA2a toward the second-second magnet area MA2b.

A length L9 of the first magnet 1151a in the optical axis direction (Z-axis direction) may differ from a length L10 of the third-first magnet 1151ca or the third-second magnet 1151cb in the optical axis direction (Z-axis direction). In an embodiment, the length L9 of the first magnet 1151a in the optical axis direction (Z-axis direction) may be smaller than the length L10 of the third-first magnet 1151ca or the third-second magnet 1151cb in the optical axis direction (Z-axis direction). With this configuration, the holder may be easily tilted with respect to the second direction (Y-axis direction).

Alternatively, the length L9 of the first magnet 1151a in the optical axis direction (Z-axis direction) may be the same as the length L10 of the third-first magnet 1151ca or the third-second magnet 1151cb in the optical axis direction.

In addition, as described above, the driving unit may include the first coil 1152a facing the first magnet 1151a, the second coil 1152b facing the second magnet 1151b, the third-first coil 1152ca facing the third-first magnet 1151ca, and the third-second coil 1152cb facing the third-second magnet 1151cb.

A length L2 of the first coil 1152a in the optical axis direction (Z-axis direction) may differ from a length L1 of the first coil 1152a in the vertical direction (X-axis direction). In addition, a length of the second coil 1152b in the optical axis direction (Z-axis direction) may differ from a length of the second coil 1152b in the vertical direction (X-axis direction).

In addition, a length L4 of the third-first coil 1152ca in the optical axis direction (Z-axis direction) may differ from a length L3 of the third-first coil 1152ca in the vertical direction (X-axis direction). In addition, a length of the third-second coil 1152cb in the optical axis direction (Z-axis direction) may differ from a length of the third-second coil 1152cb in the vertical direction (X-axis direction). Alternatively, the length L4 of the third-first coil 1152ca in the optical axis direction (Z-axis direction) may be the same as the length L3 of the third-first coil 1152ca in the vertical direction (X-axis direction).

The first coil 1152a and the third-first coil 1152ca may at least partially overlap in the optical axis direction (Z-axis direction). In addition, the second coil 1152b and the third-second coil 1152cb may at least partially overlap each other in the optical axis direction (Z-axis direction).

In addition, one end of the first coil 1152a and one end of the second coil 1152b may have the same node. Furthermore, the other end of the first coil 1152a and the other end of the second coil 1152b may have the same node. In other words, the first coil 1152a and the second coil 1152b may be formed of the same channel. In addition, one ends and the other ends of the first coil 1152a and the second coil 1152b may be wound in the same direction. More specifically, the one end of the first coil 1152a and the one end of the second coil 1152b may be connected to the same circuit pattern formed on the first board unit 1154. Alternatively, the one end of the first coil 1152a and the one end of the second coil 1152b may be connected to each of electrically connected electrode patterns of the circuit board unit in the first board unit 1154. In addition, one end of the third-first coil 1152ca and one end of the third-second coil 1152cb may be connected to the same circuit pattern formed on the first board unit 1154. Alternatively, the one end of the third-first coil 1152ca and the one end of the third-second coil 1152cb may be connected to each of the electrically connected electrode patterns of the circuit board unit in the first board unit 1154, which are electrically connected.

Therefore, the electromagnetic force generated by the first coil 1152a and the second coil 1152b may be generated to have opposite directions. For example, the electromagnetic force generated by the first coil 1152a may be generated in the second direction (Y-axis direction). The electromagnetic force generated by the second coil 1152b may be generated in a direction opposite to the second direction (Y-axis direction). In addition, at least a portion of the tilting guide part may overlap the first coil 1152a or the second coil 1152b in the horizontal direction (Y-axis direction). With this configuration, it is possible to increase rotational drive efficiency by the tilting guide part.

Alternatively, the tilting guide part may be disposed to be misaligned with the first coil 1152a or the second coil 1152b in the horizontal direction (Y-axis direction). With this configuration, it is possible to increase a tilting radius by the holder.

Furthermore, the Hall sensor unit of the driving unit may include the first Hall sensor 1153a disposed in the first coil 1152a, the second Hall sensor 1153b disposed in the second coil 1152b, the third-first Hall sensor 1153ca disposed in the third-first coil 1152ca, and the third-second Hall sensor 1153cb disposed in the third-second coil 1152cb.

Lengths L5 of the first Hall sensor 1153a and the second Hall sensor 1153b in the optical axis direction may differ from lengths L7 of the third-first Hall sensor 1153ca and the third-second Hall sensor 1153cb in the optical axis direction (Z-axis direction). For example, the lengths L5 of the first Hall sensor 1153a and the second Hall sensor 1153b in the optical axis direction may be smaller than the lengths L7 of the third-first Hall sensor 1153ca and the third-second Hall sensor 1153cb in the optical axis direction (Z-axis direction). With this configuration, the first polarity orientation and the second polarity orientation may be different (e.g., orientations perpendicular to each other). Therefore, the first Hall sensor 1153a and the third-first Hall sensor 1153ca may perform accurate position detection in response to the movements of the first magnet 1151a and the third-first magnet 1151ca in different directions. Furthermore, the first Hall sensor 1153a and the third-first Hall sensor 1153ca may at least partially overlap in the optical axis direction (Z-axis direction).

In addition, the lengths L5 of the first Hall sensor 1153a and the second Hall sensor 1153b in the optical axis direction may be smaller than lengths L6 of the first Hall sensor 1153a and the second Hall sensor 1153b in the vertical direction (X-axis direction).

In addition, the lengths L7 of the third-first Hall sensor 1153ca and the third-second Hall sensor 1153cb in the optical axis direction may be larger than lengths L8 of the third-first Hall sensor 1153ca and the third-second Hall sensor 1153cb in the vertical direction (X-axis direction).

With this configuration, it is possible to accurately detect the positions of the corresponding magnets by the first Hall sensor 1153a, the second Hall sensor 1153b, the third-first Hall sensor 1153ca, and the third-second Hall sensor 1153cb.

Furthermore, referring to FIG. 14C, the positions of the first protruding portion and the second protruding portion of the tilting guide part may be changed as described above. For example, as illustrated, the first protruding portion may be disposed outside the tilting guide part, and the second protruding portion may be disposed inside the tilting guide part. In other words, the second protruding portion spaced apart in the second direction may face the fourth holder outer surface.

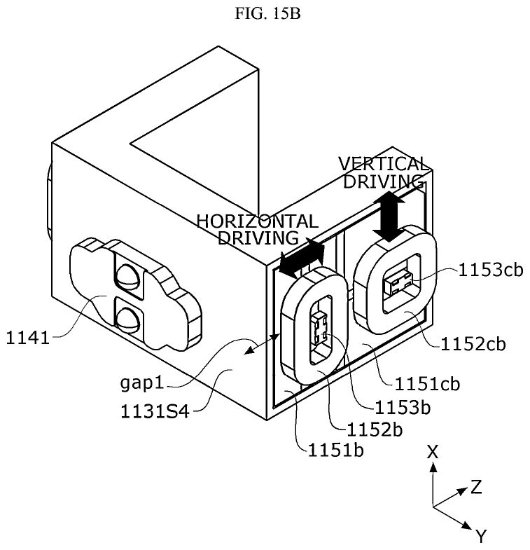

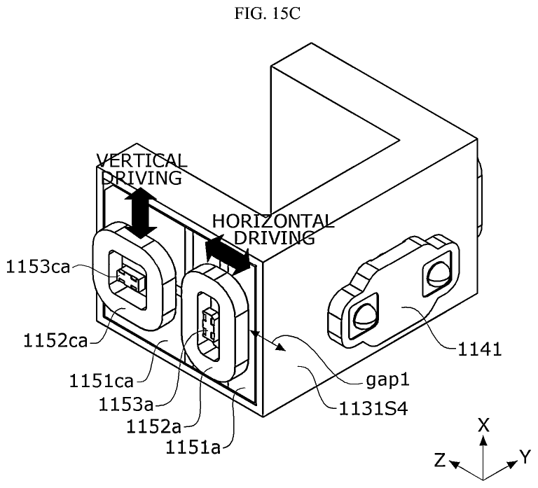

FIG. 15A is a perspective view of a holder, a tilting guide unit, and a driving unit according to another embodiment, FIG. 15B is another perspective view of the holder, the tilting guide unit, and the driving unit according to another embodiment, and FIG. 15C is a view of another example of the holder, the tilting guide unit, and the driving unit according to another embodiment.

Referring to FIGS. 15A and 15B, the driving unit or the first driving unit 1150 includes the first driving magnet 1151, the first driving coil 1152, the Hall sensor unit 1153, the first board unit 1154, and the yoke unit (not illustrated).

The first driving unit 1150 includes the first driving magnet 1151, the first driving coil 1152, the Hall sensor unit 1153 (or the first Hall sensor unit), the first board unit 1154, and the yoke unit (not illustrated). A description thereof will be made below.

The driving unit according to another embodiment may include the first magnet 1151a, the second magnet 1151b, the third-first magnet 1151ca, and the third-second magnet 1151cb. The first driving coil 1152 may include the first coil 1152a, the second coil 1152b, the third-first coil 1152ca, and the third-second coil 1152cb. The Hall sensor unit 1153 may include the first Hall sensor 1153a, the second Hall sensor 1153b, the third-first Hall sensor 1153ca, and the third-second Hall sensor 1153cb. This description excluding the following contents may be applied in the same manner.

In addition, the above-described contents excluding the following contents may be applied to the titling guide part 1141 according to another embodiment in the same manner.

According to the embodiment, as described above, the holder may be driven horizontally by the first magnet 1151a and the second magnet. In other words, the holder may be tilted with respect to the first direction by the first magnet and the second magnet. In addition, the holder may be driven vertically by the third-first magnet and third-second magnet, which have larger separation distances from the tilting guide part than the first magnet and the second magnet have. In other words, the holder may be tilted with respect to the second direction by the third-first magnet and the third-second magnet. The tilting guide part 1141 may be disposed to be spaced a predetermined distance from the fourth holder outer surface of the holder in the third direction (Z-axis direction). In addition, the first protrusion groove may be disposed in the fourth holder outer surface to accommodate the first protruding portion of the tilting guide part. Specifically, the tilting guide part 1141 may have a separation space gap1 from the first magnet 1151a or the second magnet of the holder in the optical axis direction (Z-axis direction). In other words, unlike the above description, at least a portion of the tilting guide part 1141 may overlap the first magnet 1151a or the second magnet of the holder in the horizontal direction (Y-axis direction). With this configuration, it is possible to increase a tilting angle of the holder.

Referring to FIG. 15C, the positions of the first protruding portion and the second protruding portion of the tilting guide part may be changed as described above. For example, as illustrated, the first protruding portion may be disposed outside the tilting guide part, and the second protruding portion may be disposed inside the tilting guide part. In other words, the second protruding portion spaced apart in the second direction may face the fourth holder outer surface.

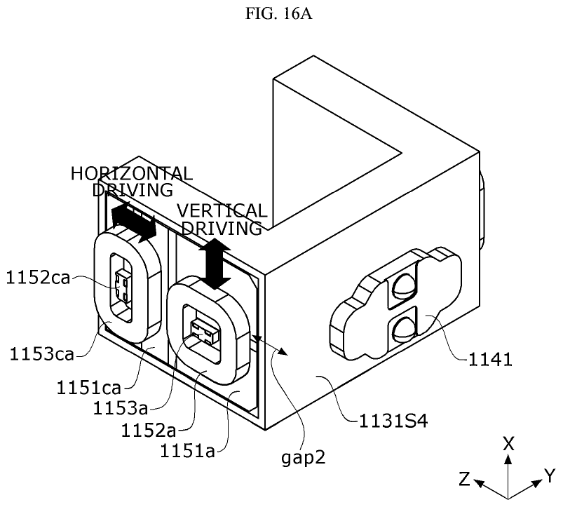

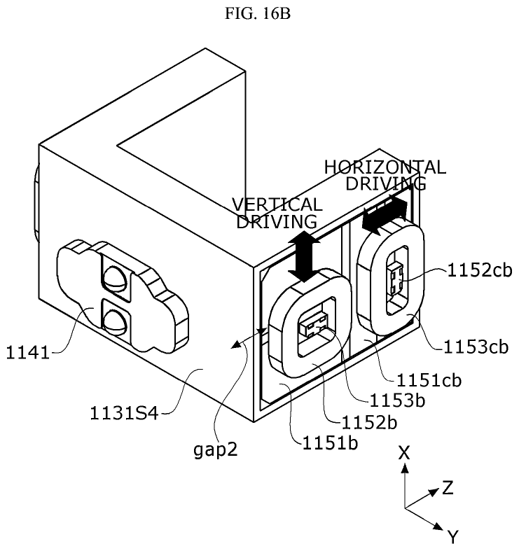

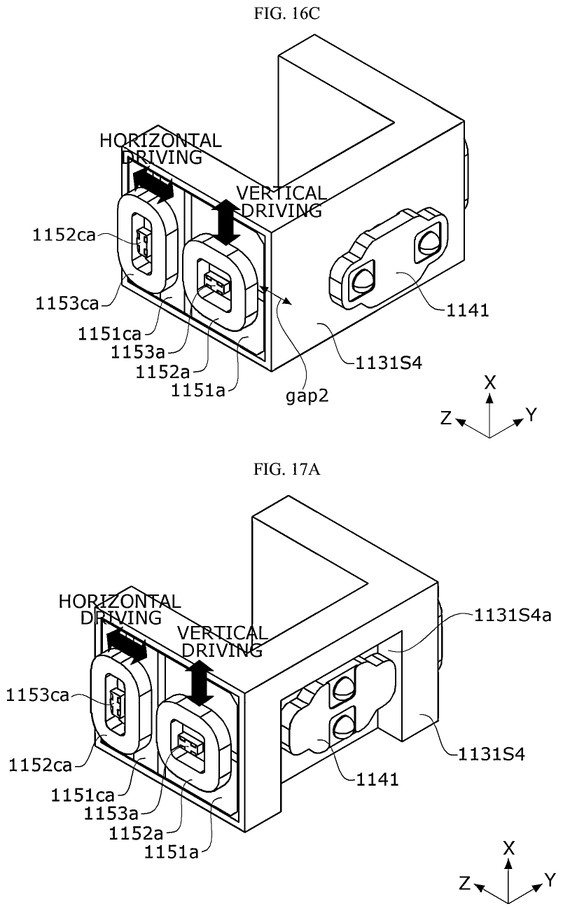

FIG. 16A is a perspective view of a holder, a tilting guide unit, and a driving unit according to still another embodiment, FIG. 16B is another perspective view of the holder, the tilting guide unit, and the driving unit according to still another embodiment, and FIG. 16C is a view of another example of the holder, the tilting guide unit, and the driving unit according to still another embodiment.

Referring to FIGS. 16A and 16B, the driving unit or the first driving unit 1150 includes the first driving magnet 1151, the first driving coil 1152, the Hall sensor unit 1153, the first board unit 1154, and the yoke unit (not illustrated).

The first driving unit 1150 includes the first driving magnet 1151, the first driving coil 1152, the Hall sensor unit 1153 (or the first Hall sensor unit), the first board unit 1154, and the yoke unit (not Hole illustrated). A description thereof will be made below.

The first driving magnet 1151 of the driving unit according to still another embodiment may include the first magnet 1151a, the second magnet 1151b, the third-first magnet 1151ca, and the third-second magnet 1151cb. The first driving coil 1152 may include the first coil 1152a, the second coil 1152b, the third-first coil 1152ca, and the third-second coil 1152cb. The Hall sensor unit 1153 may include the first Hall sensor 1153a, the second Hall sensor 1153b, the third-first Hall sensor 1153ca, and the third-second Hall sensor 1153cb. This description excluding the following contents may be applied in the same manner.

In addition, the above-described contents excluding the following contents may be applied to the titling guide part 1141 according to still another embodiment in the same manner.

In the embodiment, the holder may be driven vertically by the first magnet 1151a. In other words, the electromagnetic force generated by the first magnet 1151a and the second magnet 1151b may be generated in the first direction (X-axis direction) or a direction opposite to the first direction (X-axis direction). Therefore, the holder may be moved in the first direction (X-axis direction) or a direction opposite to the first direction (X-axis direction). In other words, the holder may be rotated with respect to the second direction (Y-axis direction).

For example, the magnetic force may be generated in the second direction (Y-axis direction) by the first magnet 1151a, and the current may flow in the first coil 1152a clockwise or counterclockwise. For example, when the current flows in the first direction (X-axis direction) in the first coil 1152a and the magnetic force is generated in the second direction (Y-axis direction), the electromagnetic force may be generated in the third direction (Z-axis direction) in the first coil 1152a. Therefore, a force (generated by the electromagnetic force) may be generated in a direction opposite to the third direction (Z-axis direction) in the first holder outer surface of the holder. In addition, when the current flows in the first direction (X-axis direction) in the second coil 1152b and the magnetic force is generated in a direction opposite to the second direction (Y-axis direction), the electromagnetic force may be generated in a direction opposite to the third direction (Z-axis direction) in the first coil 1152a. Therefore, a force (generated by the electromagnetic force) may be generated in the third direction (Z-axis direction) in the second holder outer surface of the holder. Therefore, the holder may be tilted with respect to the first direction. For example, the first holder outer surface may be positioned adjacent to the tilting guide part, and the second holder outer surface may be positioned far away from the tilting guide part.

Furthermore, according to the embodiment, the tilting guide part 1141 may be disposed to be spaced a predetermined distance from the fourth holder outer surface of the holder in the third direction (Z-axis direction). In addition, the first protrusion groove may be disposed in the fourth holder outer surface to accommodate the first protruding portion of the tilting guide part. Specifically, the tilting guide part 1141 may have a separation space gap2 from the first magnet 1151a or the second magnet of the holder in the optical axis direction (Z-axis direction). In other words, unlike the above description, at least a portion of the tilting guide part 1141 may overlap the first magnet 1151a or the second magnet of the holder in the horizontal direction (Y-axis direction). With this configuration, it is possible to increase a tilting angle of the holder.

Referring to FIG. 16C, the positions of the first protruding portion and the second protruding portion of the tilting guide part may be changed as described above. For example, as illustrated, the first protruding portion may be disposed outside the tilting guide part, and the second protruding portion may be disposed inside the tilting guide part. In other words, the second protruding portion spaced apart in the second direction may face the fourth holder outer surface.

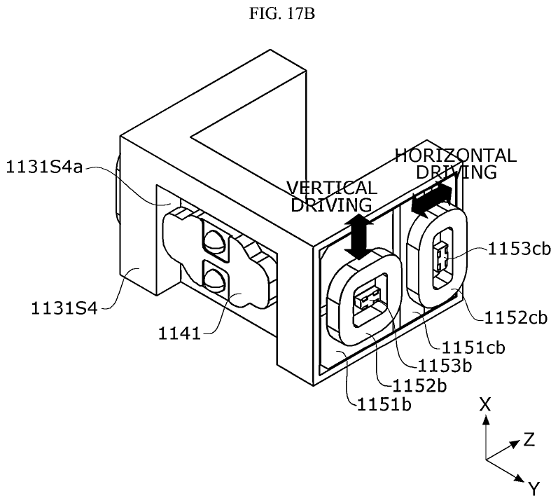

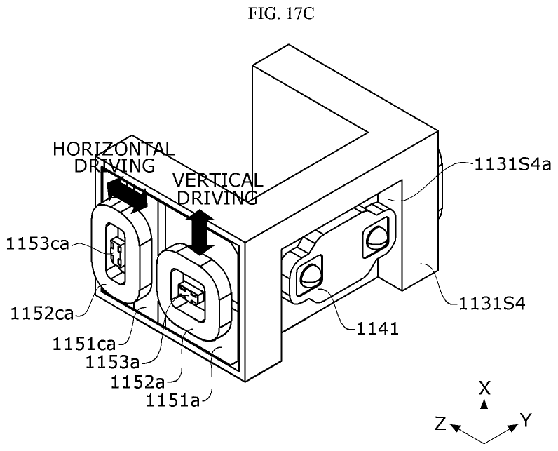

FIG. 17A is a perspective view of a holder, a tilting guide unit, and a driving unit according to a modified example, FIG. 17B is another perspective view of the holder, the tilting guide unit, and the driving unit according to the modified example, and FIG. 17C is a view of another example of the holder, the tilting guide unit, and the driving unit according to the modified example.

Referring to FIGS. 17A and 17B, the driving unit or the first driving unit 1150 includes the first driving magnet 1151, the first driving coil 1152, the Hall sensor unit 1153, the first board unit 1154, and the yoke unit (not illustrated).

The first driving unit 1150 includes the first driving magnet 1151, the first driving coil 1152, the Hall sensor unit 1153 (or the first Hall sensor unit), the first board unit 1154, and the yoke unit (not Hole illustrated). A description thereof will be made below.

The first driving magnet 1151 of the driving unit according to the modified example may include the first magnet 1151a, the second magnet 1151b, the third-first magnet 1151ca, and the third-second magnet 1151cb. The first driving coil 1152 may include the first coil 1152a, the second coil 1152b, the third-first coil 1152ca, and the third-second coil 1152cb. The Hall sensor unit 1153 may include the first Hall sensor 1153a, the second Hall sensor 1153b, the third-first Hall sensor 1153ca, and the third-second Hall sensor 1153cb. This description excluding the following contents may be applied in the same manner.

In addition, the above-described contents excluding the following contents may be applied to the titling guide part 1141 according to the modified example in the same manner.

In the embodiment, the holder may be driven vertically by the first magnet 1151a. In other words, the electromagnetic force generated by the first magnet 1151a and the second magnet 1151b may be generated in the first direction (X-axis direction) or a direction opposite to the first direction (X-axis direction). Therefore, the holder may be moved in the first direction (X-axis direction) or a direction opposite to the first direction (X-axis direction). In other words, the holder may be rotated with respect to the second direction (Y-axis direction).

For example, the magnetic force may be generated in the second direction (Y-axis direction) by the first magnet 1151a, and the current may flow in the first coil 1152a clockwise or counterclockwise. For example, when the current flows in the first direction (X-axis direction) in the first coil 1152a and the magnetic force is generated in the second direction (Y-axis direction), the electromagnetic force may be generated in the third direction (Z-axis direction) in the first coil 1152a. Therefore, a force (generated by the electromagnetic force) may be generated in a direction opposite to the third direction (Z-axis direction) in the first holder outer surface of the holder. In addition, when the current flows in the first direction (X-axis direction) in the second coil 1152b and the magnetic force is generated in a direction opposite to the second direction (Y-axis direction), the electromagnetic force may be generated in a direction opposite to the third direction (Z-axis direction) in the first coil 1152a. Therefore, a force (generated by the electromagnetic force) may be generated in the third direction (Z-axis direction) in the second holder outer surface of the holder. Therefore, the holder may be tilted with respect to the first direction. For example, the first holder outer surface may be positioned adjacent to the tilting guide part, and the second holder outer surface may be positioned far away from the tilting guide part.

Furthermore, as described in the embodiment, the tilting guide part 1141 may be seated in the fourth seating groove of the fourth holder outer surface 1131S4. The first protrusion groove may be disposed in the fourth holder outer surface to accommodate the first protruding portion of the tilting guide part. Furthermore, at least a portion of the tilting guide part may overlap the first magnet 1151a and the second magnet 1151b in the second direction (Y-axis direction). Therefore, it is possible to increase driving efficiency for the horizontal movement by the first magnet 1151a and the second magnet and the vertical movement by the third-first magnet 1151ca and third-second magnet.

Referring to FIG. 17C, the positions of the first protruding portion and the second protruding portion of the tilting guide part may be changed as described above. For example, as illustrated, the first protruding portion may be disposed outside the tilting guide part, and the second protruding portion may be disposed inside the tilting guide part. In other words, the second protruding portion spaced apart in the second direction may face the fourth holder outer surface.

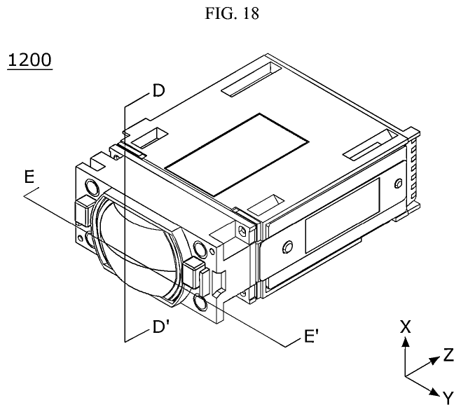

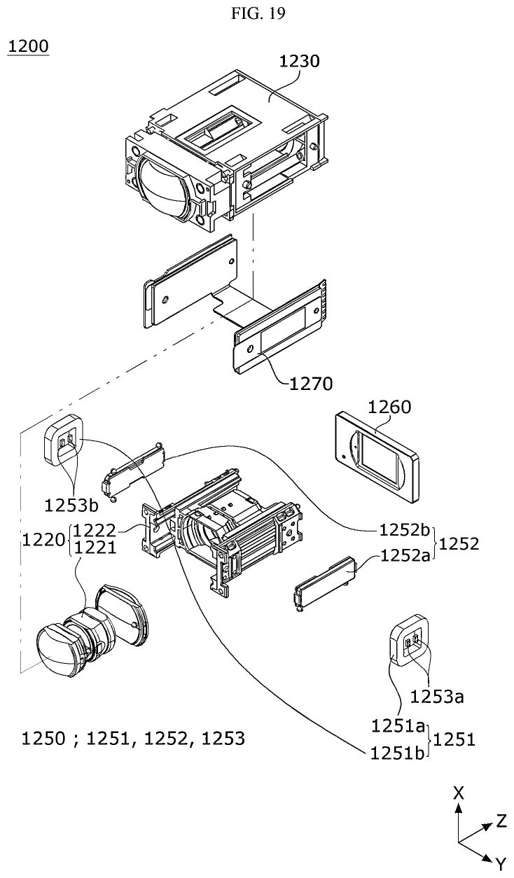

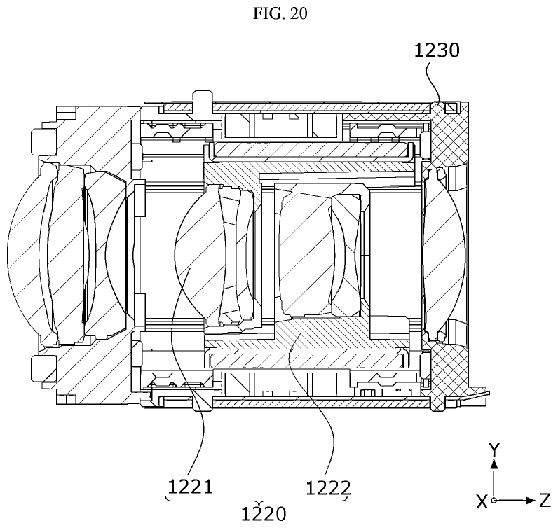

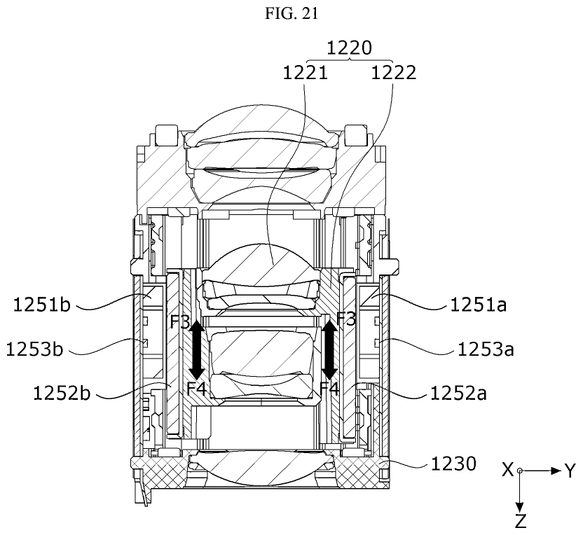

FIG. 18 is a perspective view of a second camera actuator according to the embodiment, FIG. 19 is an exploded perspective view of the second camera actuator according to the embodiment, FIG. 20 is a cross-sectional view along line D-D′ in FIG. 18, and FIG. 21 is a cross-sectional view along line E-E′ in FIG. 18.

Referring to FIGS. 18 to 21, the second camera actuator 1200 according to the embodiment may include a lens unit 1220, a second housing 1230, a second driving unit 1250, a base unit (not illustrated), and a second board unit 1270. Furthermore, the second camera actuator 1200 may further include a second shield can (not illustrated), an elastic unit (not illustrated), and a bonding member (not illustrated). Furthermore, the second camera actuator 1200 according to the embodiment may further include the image sensor IS.

The second shield can (not illustrated) may be positioned in one area (e.g., an outermost side) of the second camera actuator 1200 and positioned to surround the components (the lens unit 1220, the second housing 1230, the second driving unit 1250, the base unit (not illustrated), the second board unit 1270, and the image sensor IS) to be describe below.

The second shield can (not illustrated) can block or attenuate electromagnetic waves generated from the outside. Therefore, it is possible to reduce the occurrence of malfunction in the second driving unit 1250.

The lens unit 1220 may be positioned in the second shield can (not illustrated). The lens unit 1220 may be moved in the third direction (Z-axis direction). Therefore, the above-described AF function may be performed.

Specifically, the lens unit 1220 may include a lens assembly 1221 and a bobbin 1222.

The lens assembly 1221 may include at least one lens. In addition, although a plurality of lens assemblies 1221 may be formed, the following description will be made based on one lens assembly.

The lens assembly 1221 may be coupled to the bobbin 1222 and moved by an electromagnetic force generated from a fourth magnet 1252a and a fifth magnet 1252b coupled to the bobbin 1222 in the third direction (Z-axis direction).

The bobbin 1222 may include an opening area surrounding the lens assembly 1221. In addition, the bobbin 1222 may be coupled to the lens assembly 1221 by any of various methods. In addition, the bobbin 1222 may include a groove in a side surface thereof and may be coupled to the fourth magnet 1252a and the second magnet 1252b through the groove. A bonding member or the like may be applied to the groove.

In addition, the bobbin 1222 may be coupled to elastic units (not illustrated) on an upper end and a lower end thereof. Therefore, the bobbin 1222 may be supported by the elastic units (not illustrated) while moving in the third direction (Z-axis direction). In other words, the bobbin 1222 may be maintained in the third direction (Z-axis direction) while a position thereof is maintained. The elastic unit (not illustrated) may be formed of a leaf spring.

The second housing 1230 may be disposed between the lens unit 1220 and the second shield can (not illustrated). In addition, the second housing 1230 may be disposed to surround the lens unit 1220.

The second housing 1230 may have a hole formed in a side portion thereof. A fourth coil 1251a and a fifth coil 1251b may be disposed in the hole. The hole may be positioned to correspond to the above-described groove of the bobbin 1222.

The fourth magnet 1252a may be positioned to face the fourth coil 1251a. In addition, the second magnet 1252b may be positioned to face the fifth coil 1251b.

The elastic unit (not illustrated) may include a first elastic member (not illustrated) and a second elastic member (not illustrated). The first elastic member (not illustrated) may be coupled to an upper surface of the bobbin 1222. The second elastic member (not illustrated) may be coupled to a lower surface of the bobbin 1222. In addition, the first elastic member (not illustrated) and the second elastic member (not illustrated) may be formed of a leaf spring as described above. In addition, the first elastic member (not illustrated) and the second elastic member (not illustrated) may provide elasticity for moving the bobbin 1222.

The second driving unit 1250 may provide driving forces F3 and F4 for moving the lens unit 1220 in the third direction (Z-axis direction). The second driving unit 1250 may include the second driving coil 1251 and the second driving magnet 1252.

The lens unit 1220 may be moved in the third direction (Z-axis direction) by the electromagnetic force generated between the second driving coil 1251 and the second driving magnet 1252.

The second driving coil 1251 may include the fourth coil 1251a and the fifth coil 1251b. The fourth coil 1251a and the fifth coil 1251b may be disposed in the holes formed in the side portions of the second housing 1230. In addition, the fourth coil 1251a and the fifth coil 1251b may be electrically connected to the second board unit 1270. Therefore, the fourth coil 1251a and the fifth coil 1251b may receive a current or the like through the second board unit 1270.

The second driving magnet 1252 may include the fourth magnet 1252a and the fifth magnet 1252b. The fourth magnet 1252a and the fifth magnet 1252b may be disposed in the above-described groove of the bobbin 1222 and positioned to correspond to the fourth coil 1251a and the fifth coil 1251b.

The base unit (not illustrated) may be positioned between the lens unit 1220 and the image sensor IS. A component such as a filter may be fixed to the base unit (not illustrated). In addition, the base unit (not illustrated) may be disposed to surround the image sensor IS. With this configuration, since the image sensor IS is free from foreign substances and the like, it is possible to improve the reliability of the element.

In addition, the second camera actuator may be a zooming actuator or an AF actuator. For example, the second camera actuator may support one lens or a plurality of lenses and perform an AF function or a zooming function by moving the lenses according to a predetermined control signal of a controller.

In addition, the second camera actuator may be a fixed zoom or a continuous zoom. For example, the second camera actuator may provide a movement of the lens assembly 1221.

In addition, the second camera actuator may be formed of a plurality of lens assemblies. For example, at least one of a first lens assembly, a second lens assembly (not illustrated), a third lens assembly (not illustrated), and a guide pin (not illustrated) may be disposed in the second camera actuator. The above-described contents may be applied thereto. Therefore, the second camera actuator may perform a high-magnification zooming function through the driving unit. For example, although the first lens assembly (not illustrated) and the second lens assembly (not illustrated) may be moving lenses that move through the driving unit and the guide pin (not illustrated) and the third lens assembly (not illustrated) may be a fixed lens, the present invention is not limited thereto. For example, the third lens assembly (not illustrated) may perform a function for a focator by which light forms an image at a specific position, and the first lens assembly (not illustrated) may perform a function for a variator for re-forming an image formed by the third lens assembly (not illustrated), which is the focator, at another position. Meanwhile, the first lens assembly (not illustrated) may be in a state in which a magnification change is large because a distance to a subject or an image distance is greatly changed, and the first lens assembly (not illustrated), which is the variator, may play an important role in a focal length or magnification change of the optical system. Meanwhile, imaging points of an image formed by the first lens assembly (not illustrated), which is the variator, may be slightly different depending on a position. Therefore, the second lens assembly (not illustrated) may perform a position compensation function for the image formed by the variator. For example, the second lens assembly (not illustrated) may perform a function for a compensator for accurately forming an image at an actual position of the image sensor using the imaging points of the image formed by the second lens assembly (not illustrated) that is the variator.

The image sensor IS may be positioned inside or outside the second camera actuator. In the embodiment, as illustrated, the image sensor IS may be positioned inside the second camera actuator. The image sensor IS may receive light and convert the received light into an electrical signal. In addition, the image sensor IS may include a plurality of pixels in the form of an array. In addition, the image sensor IS may be positioned on the optical axis.

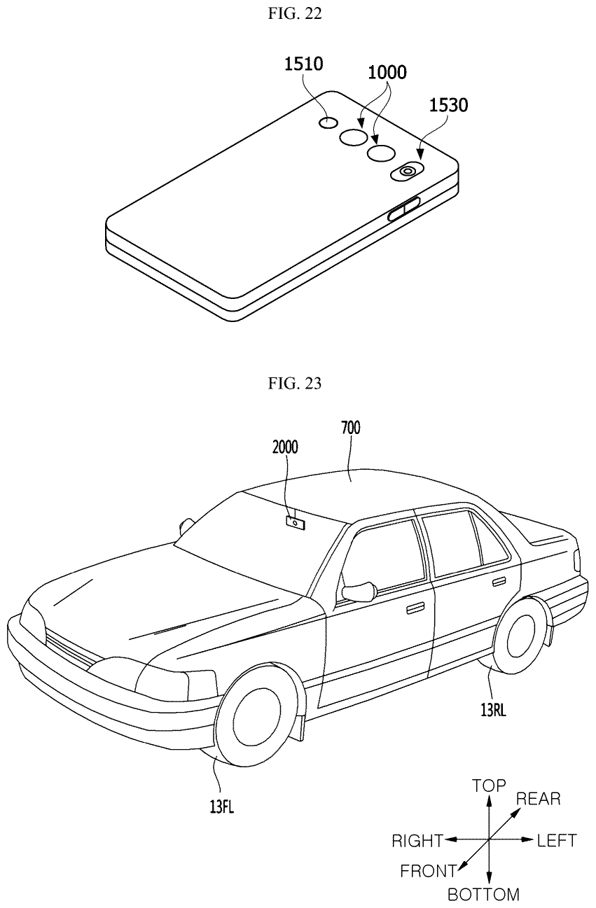

FIG. 22 is a perspective view of a mobile terminal to which the camera module according to the embodiment is applied.

As illustrated in FIG. 22, a mobile terminal 1500 according to the embodiment may include a camera module 1000, a flash module 1530, and an AF device 1510, which are provided on a rear surface thereof.

The camera module 1000 may include an image photographing function and an AF function. For example, the camera module 1000 may include the AF function using an image.

The camera module 1000 processes an image frame of a still image or a moving image obtained by an image sensor in a photographing mode or a video call mode.

The processed image frame may be displayed on a predetermined display and stored in a memory. A camera (not illustrated) may also be disposed on a front surface of a body of the mobile terminal.

For example, the camera module 1000 may include a first camera module 1000A and a second camera module 1000B, and the first camera module 1000A may implement an OIS function together with an AF or zooming function. In addition, the second camera module 1000B may implement the AF, zooming, and OIS functions. In this case, since the first camera module 1000A includes both the above-described first camera actuator and second camera actuator, it is possible to easily miniaturize the camera device or the camera module by changing an optical path.

The flash module 1530 may include a light emitting device for emitting light therein. The flash module 1530 may be operated by a camera operation of the mobile terminal or a user's control.

The AF device 1510 may include one of a package of a surface light emitting laser device as a light emitting unit.

The AF device 1510 may include the AF function using a laser. The AF device 1510 may be mainly used in a condition that the AF function using the image of the camera module 1000 is degraded, for example, a proximity of 10 m or less or dark environment.

The AF device 1510 may include a light emitting unit including a vertical cavity surface emitting laser (VCSEL) semiconductor device and a light receiving unit for converting light energy into electrical energy, such as a photodiode.

FIG. 23 is a perspective view of a vehicle to which the camera module according to the embodiment is applied.

For example, FIG. 23 is an external view of the vehicle including a vehicle driving assistance device to which the camera module 1000 according to the embodiment is applied.

Referring to FIG. 23, a vehicle 700 in the embodiment may include wheels 13FL and 13FR, which are rotated by a power source, and a predetermined sensor. Although the sensor may be a camera sensor 2000, the present invention is not limited thereto.

The camera sensor 2000 may be a camera sensor to which the camera module 1000 according to the embodiment is applied. The vehicle 700 according to the embodiment may acquire image information through the camera sensor 2000 for photographing a front image or a surrounding image, determine a situation in which a lane line is not identified using the image information, and generate a virtual lane line when the lane line is not identified.

For example, the camera sensor 2000 may acquire a front image by photographing a view in front of the vehicle 700, and a processor (not illustrated) may acquire image information by analyzing an object included in the front image.

For example, when a lane line, an adjacent vehicle, a traveling obstacle, and objects, such as a median, a curb, or a tree corresponding to an indirect road mark, are photographed in the image photographed by the camera sensor 2000, the processor may detect the object and include the detected object in the image information. At this time, the processor may further supplement the image information by acquiring distance information to the object detected through the camera sensor 2000.

The image information may be information on the object photographed in the image. The camera sensor 2000 may include an image sensor and an image processing module.

The camera sensor 2000 may process still images or moving images obtained by the image sensor (e.g., a complementary metal-oxide semiconductor (CMOS) or a charge-coupled device (CCD)).

The image processing module may process the still images or moving images acquired through the image sensor to extract necessary information, and transmit the extracted information to the processor.

In this case, although the camera sensor 2000 may include a stereo camera for improving the measurement accuracy of the object and further securing information such as a distance between the vehicle 700 and the object, the present invention is not limited thereto.

Although the embodiments have been mainly described above, these are only illustrative and do not limit the present invention, and those skilled in the art to which the present invention pertains can know that various modifications and applications not exemplified above are possible without departing from the essential characteristics of the embodiments. For example, each component specifically illustrated in the embodiments may be implemented by modification. In addition, differences related to these modifications and applications should be construed as being included in the scope of the present invention defined in the appended claims.

1. A camera actuator comprising:
a housing;
a mover disposed in the housing and including an optical member;
a tilting guide part configured to guide tilting of the mover; and
a driving unit disposed in the housing and configured to drive the mover,
wherein the driving unit includes a first magnet and a third-first magnet disposed on one surface of the mover, and a second magnet and a third-second magnet disposed on the other surface opposite to the one surface, and
wherein the first magnet and the second magnet are closer to the tilting guide part than the third-first magnet and the third-second magnet are and have different areas from the third-first magnet and the third-second magnet.

2. The camera actuator of claim 1, wherein the first magnet and the second magnet correspond to each other, and
wherein the third-first magnet and the third-second magnet correspond to each other.

3. The camera actuator of claim 1, wherein the first magnet includes a first-first magnet area and a first-second magnet area having different polarities,
wherein the second magnet includes a second-first magnet area and a second-second magnet area having different polarities,
wherein the third-first magnet includes a third-first magnet area and a third-second magnet area having different polarities, and
wherein the third-second magnet includes a third-third magnet area and a third-fourth magnet area having different polarities.

4. The camera actuator of claim 3, wherein a first polarity orientation differs from a second polarity orientation,
wherein the first polarity orientation is an orientation from the third-first magnet area to the third-second magnet area or an orientation from the third-third magnet area to the third-fourth magnet area, and
wherein the second polarity orientation is an orientation from the first-first magnet area to the first-second magnet area or an orientation from the second-first magnet area to the second-second magnet area.

5. The camera actuator of claim 3, wherein the first-first magnet area has the same polarity as any one of the second-first magnet area and the second-second magnet area, and
wherein the first-second magnet area has the same polarity as the other of the second-first magnet area and the second-second magnet area.

6. The camera actuator of claim 5, wherein the first-first magnet area and the first-second magnet area are sequentially disposed,
wherein the second-first magnet area is disposed above the second-second magnet area, and
wherein the first-second magnet area has a different polarity from the second-first magnet area.

7. The camera actuator of claim 3, wherein a length of the first magnet in an optical axis direction differs from a length of the third-first magnet or the third-second magnet in the optical axis direction, and
wherein the optical axis direction corresponds to a moving direction of light reflected by the optical member.

8. The camera actuator of claim 1, wherein a length of the first magnet in an optical axis direction is the same as a length of the second magnet in the optical axis direction.

9. The camera actuator of claim 1, wherein the driving unit includes a driving coil including a first coil facing the first magnet, a second coil facing the second magnet, a third-first coil facing the third-first magnet, and a third-second coil facing the third-second magnet.

10. The camera actuator of claim 9, wherein a length of the first coil in an optical axis direction differs from a length of the first coil in a vertical direction.

11. The camera actuator of claim 9, wherein a length of the third-first coil in an optical axis direction differs from a length of the third-first coil in a vertical direction.

12. The camera actuator of claim 9,
wherein a length of the first coil in an optical axis direction is smaller than a length of the third-first coil in the optical axis direction.

13. The camera actuator of claim 9,
wherein the first coil and the third-first coil at least partially overlap in the optical axis direction, and the second coil and the third-second coil may at least partially overlap in the optical axis direction.

14. The camera actuator of claim 9,
wherein one end of the first coil and one end of the second coil have the same node, and the other end of the first coil and the other end of the second coil have the same node.

15. The camera actuator of claim 9,
wherein the first coil and the third-first coil at least partially overlap in the optical axis direction, and the second coil and the third-second coil at least partially overlap in the optical axis direction.

16. The camera actuator of claim 9,
wherein at least a portion of the tilting guide part overlaps the first coil or the second coil in a horizontal direction.

17. The camera actuator of claim 9,
wherein the driving unit includes a Hall sensor unit including a first Hall sensor disposed in the first coil, a second Hall sensor disposed in the second coil, a third-first Hall sensor disposed in the third-first coil, and a third-second Hall sensor disposed in the third-second coil.

18. The camera actuator of claim 17,
wherein lengths of the first Hall sensor and the second Hall sensor in the optical axis direction differ from lengths of the third-first Hall sensor and the third-second Hall sensor in the optical axis direction.

19. The camera actuator of claim 17,
wherein the first Hall sensor and the third-first Hall sensor at least partially overlap in the optical axis direction.

20. The camera actuator of claim 1,
wherein the first magnet and the second magnet are closer to the tilting guide part than the third-first magnet and the third-second magnet and have a smaller areas from the third-first magnet and the third-second magnet.
